(19) United States
(12) Patent Application Publication
(10) Pub. No.: US 2025/0038701 A1
(43) Pub. Date: Jan. 30, 2025

(54) A CABLE SUPPORTED MOBILE SOLAR PANEL ARRAY APPARATUS AND METHOD

(71) Applicant: Erez DOR, Rishon le Zion (IL)

(72) Inventor: Erez DOR, Rishon le Zion (IL)

(21) Appl. No.: 18/715,767

(22) PCT Filed: Dec. 4, 2022
(86) PCT No.: PCT/IL2022/051287

§ 371 Date: Jun. 3, 2024

Related U.S. Application Data
(60) Provisional application No. 63/286,125, filed on Dec. 6, 2021.
(60) Provisional application No. 63/307,129, filed on Feb. 6, 2022.

(51) Int. Cl. H02S 20/32

(52) U.S. Cl. CPC H02S 20/32

(57) ABSTRACT

The present invention in some embodiments thereof relates to an easy maintenance cable supported array supplying electric power. A cable-based solar power arrays may be elevated and/or suspended above ground level. In some embodiments, the current invention facilitates practical and cost-effective maintenance of a suspended solar array. For example, maintenance of solar panels may include, for example, cleaning the panels. For example, the system may include a conveyer subsystem that enables components to be lowered one part after the other and/or row by row for maintenance. Optionally, at the end of the maintenance process the conveyer may reinstate the cable-based solar power array back to its previous position above the ground. Optionally, repositioning and/or maintenance is achieved without disconnecting the cable-based grid from its anchoring points and/or without losing tension in the grid and/or affecting the spread configuration of the cable-based grid.

### RELATED APPLICATION/S

This application claims the benefit of priority under 35 USC § 119(e) of U.S. Provisional Patent Application No. 63/286,125 filed 6 Dec. 2021, the contents of which are incorporated herein by reference in their entirety.

This application claims the benefit of priority under 35 USC § 119(e) of U.S. Provisional Patent Application No. 63/307,129 filed 6 Feb. 2022, the contents of which are incorporated herein by reference in their entirety.

### BACKGROUND OF THE INVENTION

The present invention in some embodiments thereof relates to a cable supported solar panel array and more particularly but not exclusively to an easy maintenance cable supported array supplying electric power.

A solar photovoltaic power plant is in most cases a land intensive project, and finding a location for a large-scale project is a growing problem, and a system that could allow a dual use for a land area is a much needed and long sought solution.

U.S. Pat. No. 5,433,259 appears to disclose, “A retractable awning includes a weather protective articulated slat system for protecting the awning when in a retracted position with a solar cell panel incorporated into an articulated slat and connected to a battery for charging the battery.”

U.S. Pat. No. 10,560,050 appears to disclose, “Apparatus, systems and methods are provided for solar awnings or canopies that include rigid solar modules, for example photovoltaic cells or panels. The awnings have solar modules or panels stacked together substantially vertically (e.g., each module is oriented vertically with respect to the next module). The solar modules in the stack are interconnected to each other, such that each solar module is connected electrically and mechanically to adjacent solar modules. The first solar module in the stack of modules is fixed to one end of the base of the awning. The base of the awning is typically mounted to a building, vehicle, mobile home, or other appropriate structure. The last solar module in the stack is attached to a lead arm of the awning. The lead arm moves back and forth (e.g., away and toward) from the base of the awning to enable the expansion or retraction of the awning.”

US Patent Application Publication no. 20180102734 appears to disclose, “A method and system for creating a shaded area using retractably mounted photovoltaic cells is disclosed that utilizes an energy and shade producing canopy of retractable photovoltaic cells or panels that is deployed to create shade and electricity when desired and retracted when not in use.”

US Patent Application Publication no. 20040055633 appears to disclose, “A device intended to be used as a shade, awning, blind and swimming pool cover includes a photocurrent-generating fabric and a support for winding and storing the fabric. The support is formed by an axisymmetric tube of regular polygonal cross-section around the periphery of which the fabric is wound. The photo current-generating fabric includes a layer of interconnected photovoltaic cells.”

US Patent Application Publication no. 20190186149 appears to disclose, “An electric blinds roof structure provided in this invention includes a top frame, and at least a group of blinds is installed at the top frame. Each group of blinds includes a plurality of slats, a linkage strip, and an electric control mechanism, each slat is rotatably installed at the top frame, and each slat is directly hinged to the linkage strip or hinged to the linkage strip through a fixing member fixed at the slat. The electric control mechanism is used to drive at least one linkage strip to move thus to control opening and closing of the slats. This invention can drive the linkage strip to move through the electric control mechanism, thereby controlling the opening and closing of slats corresponding to blinds, and operation is convenient and reliable compared to the operation mode of rolling a rolling rod in the prior art.”

U.S. Pat. No. 9,954,478 appears to disclose, “Systems and methods for disposing and supporting a solar panel array are disclosed. The embodiments comprise various combinations of cables, support columns, and pod constructions in which to support solar panels. Special installations of the system can include systems mounted over structures such as parking lots, roads, aqueducts, and other bodies of water. Simplified support systems with a minimum number of structural elements can be used to create effective support for solar panel arrays of varying size and shapes. These simplified systems minimize material requirements and labor for installation of the systems.”

U.S. Pat. No. 8,875,450 appears to disclose, “Systems and methods for supporting a solar panel array are disclosed, with embodiments specifically directed to spanning bodies of water such as aqueducts, canals, or other waterways. Cable truss assemblies are used to support panel receivers and solar panels mounted over the panel receivers. The cable truss assemblies are supported on groups of columns or other vertically extending support members anchored in the ground. Cable anchor lines may supplement anchoring and support of the installed solar panel array. Embodiments of the system include various combinations of supporting cables making up the cable truss assemblies. A method is also provided for construction of the solar panel array. Lengthy and continuous spans of the solar panel array can be installed over waterways by use of the cable truss assemblies. The solar panel arrays produce power, and simultaneously reduce evaporation from the waterways, resulting in conservation of water.”

U.S. Pat. No. 10,920,487 appears to disclose, “A self-powered dynamic photovoltaic sunshade system having sunshades constructed of lightweight ETFE panels covered with at least one thin film of photovoltaic cells. The sunshades track the sun by light detectors, and move against the sun from east to west to block direct rays. The ETFE fabric is stretched on a lightweight frame, which rotates vertically around its axis as a pivotal panel for maximum solar protection. Sunshades rotate to face the sun by day, and reset to a starting position at night. Each sunshade is rotated by a stepped electric motor, powered by thin film(s) of solar photovoltaic cells. Sunshades are suspended between an electric motor shaft and a lower hinge. The sunshades are designed to provide sustainable dynamic shading for building facades exposed to different sun angles, are self-powered, and can generate electric power for other building functions, such as lighting and fan ventilation inside a building.”

U.S. Pat. No. 4,782,761 appears to disclose, “A cable tensioning device for ski lifts or aerial cableways of the kind comprising an endless transporting cable (1) extending between two rotatable wheels (2) mounted on carriers (4), at least one of the wheels being movable by the fact that its associated carrier is slidably movable relative to a foundation in order to keep the cable tensioned. The carrier (4) is by means of a nut device connected to a suitably rotatable screw (13). A tension sensing device is associated to a power source (19) for causing a rotating relative movement between the screw (13) and the nut device in order to, at an occurred change in the tension of the cable (1), start the power source (15) and effect a movement of the wheel (2) in question a distance relative to the foundation that corresponds to the actual tensional change.”

U.S. Pat. No. 4,782,761 appears to disclose, “A cable tensioning apparatus and method for automatically maintaining and adjusting the tension forces in an endless cable for a ski lift, aerial tramway, etc. is disclosed. The apparatus includes a carriage on which the cable is carried, a pneumatic carriage displacement apparatus in the form of a piston and cylinder, a source of gas under pressure, and a regulator and relief valve connected to establish and maintain a pressure within the cylinder which falls between predetermined minimum and maximum pressures. As the aerial tramway is subject to passenger or cargo loading and ambient conditions which change the tension forces, the pressure in the pneumatic cylinder will vary within the preselected range, and upon a change in the tension force beyond the range, gas is automatically exhausted from or interjected into the pneumatic cylinder to maintain tension forces within the preselected range.”

Additional art includes US Patent Application Publication no. 20110197418 and International Published Application no. WO2020017753.

### SUMMARY OF THE INVENTION

According to an aspect of some embodiments of the invention, there is provided a solar power harvesting system including: a flexible solar array including a cable-based lattice and a plurality of solar panels attached thereto and at least partially elevated above a ground surface; a conveyer configured for transporting the flexible solar array such that a portion of the plurality of solar panels moves back and forth between a predetermined maintenance area and a predetermined power generating position.

According to some embodiments of the invention, the conveyer includes a cable guide guiding a guide cable to perform the transporting.

According to some embodiments of the invention, the conveyer includes a small diameter drive wheel driving the guide cable and wherein the cable guide includes a rotating large diameter component directing movement the flexible solar array around a change in direction.

According to some embodiments of the invention, the cable guide includes a channel wherein the guide cable passes through an internal space of the channel and a portion of the cable-based lattice passes through a side slit of the channel.

According to some embodiments of the invention, the cable guide includes series of rings wherein the guide cable passes through an internal space of the rings and a portion of the cable-based lattice passes through an opening in each of the rings.

According to some embodiments of the invention, the large diameter component includes protruding teeth.

According to some embodiments of the invention, the conveyer includes two guide cables attached to opposing sides of the flexible solar array and a respective cable guide for guiding each guide cable.

According to some embodiments of the invention, the flexible solar array has a form of a belt.

According to some embodiments of the invention, the belt includes a continuous belt.

According to some embodiments of the invention, a portion of the plurality of panels is configured for tilting including an angle adjusted apparatus to control an angle of the tilting.

According to some embodiments of the invention, an angle adjusting apparatus including a tension controlling device to control an angle of the tilting.

According to some embodiments of the invention, a panel of the plurality of panels is attached to the cable-based lattice on a first edge and free to move at a second edge and wherein the angle adjusting apparatus controls a position of the free edge.

According to some embodiments of the invention, the solar power harvesting system further includes a coupler connecting the second edge of multiple panels and constraining the second edge of the multiple panels to move together.

According to some embodiments of the invention, the flexible solar array is supported by a plurality of suspenders of differing lengths.

According to some embodiments of the invention, the solar power harvesting system further includes a rigid support under a panel in the maintenance area.

According to some embodiments of the invention, the solar power harvesting system further includes a mid-grid support passing across a width of the cable-based lattice and supporting a cross section of the grid.

According to some embodiments of the invention, the maintenance area is elevated above the ground surface.

According to some embodiments of the invention, the solar power harvesting system further includes a panel cleaning apparatus.

According to some embodiments of the invention, the solar power harvesting system further includes another renewable energy harvesting device.

According to some embodiments of the invention, the solar power harvesting system further includes a wind blocking device.

According to some embodiments of the invention, the solar power harvesting system further includes a tensioning device configured to increase and decries tension in at least one cable in the flexible cable-based solar array.

According to an aspect of some embodiments of the invention, there is provided a solar power harvesting system including: a flexible solar array including a cable-based lattice and a plurality of solar panels attached thereto and at least partially floating on a body of water; a conveyer configured for transporting the flexible solar array such that a portion of the plurality of solar panels moves back and forth between a predetermined maintenance area and a predetermined power generating position.

According to an aspect of some embodiments of the invention, there is provided a method of solar power harvesting including: Suspending a flexible solar array on a guide cable above an object; Conveying the guide cable via a pulley on a small diameter drive wheel thereby moving the flexible solar array while directing movement of the flexible solar array around a change of direction with a rotating large diameter component thereby transporting a portion of the array between a maintenance area and a power generating position.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a cable-based grid 103 in accordance with an embodiment of the current invention;

FIG. 2 is a schematic illustration of a cable-based grid including a rotating axel type of coupling in accordance with an embodiment of the current invention;

FIG. 3A is a schematic illustration of an apparatus 308 designed to adjust an angle of a solar panel 101 in accordance with an embodiment of the current invention;

FIG. 3B is a schematic illustration of an apparatus 308 designed to adjust an angle of a solar panel 101 in accordance with an embodiment of the current invention;

FIGS. 4A and 4B are schematic side and rear views of a conveying apparatuses in accordance with an embodiment of the current invention;

FIG. 4C is schematic side view of a conveying apparatuses in accordance with an embodiment of the current invention;

FIG. 5 is a schematic illustrating of conveying apparatuses being used to roll a cable-based grid around a direction change in accordance with an embodiment of the current invention;

FIGS. 6A and 6B are schematic side and rear views of a conveying apparatuses in accordance with an embodiment of the current invention;

FIG. 7 is a schematic rear view of conveying apparatuses being used to roll a cable-based grid around a direction change in accordance with an embodiment of the current invention;

FIG. 8 is a schematic illustrating of a conveying apparatuses being used to convey cable-based grid in accordance with an embodiment of the current invention;

FIG. 9 is a schematic cross-sectional illustration of a guiding apparatus with an internal channel and a side slit in accordance with an embodiment of the current invention;

FIG. 10A is a schematic cross-sectional illustration of a guiding apparatus with a guide including an open ring in accordance with an embodiment of the current invention;

FIG. 10B is a schematic cross-sectional illustration of a guiding apparatus with a guide including a series of open rings in accordance with an embodiment of the current invention;

FIG. 11 is a schematic illustration of an embodiment of a dynamic tension creating device maintaining tension on a lattice of cables in accordance with an embodiment of the current invention;

FIG. 12 is a side view of a conveying apparatus having a complex path for guiding a guiding cable to drive a cable-based grid along the path in a solar power array in accordance with an embodiment of the current invention;

FIG. 13 is a schematic illustration of a dynamic cable length controlling device in accordance with an embodiment of the current invention;

FIG. 14A is a view of a mobile cable-based power array in accordance with an embodiment of the current invention;

FIG. 14B is a close-up view of the exemplary conveying system of the embodiment of FIG. 14A;

FIG. 15 is a view of a mobile cable-based power array in accordance with an embodiment of the current invention;

FIG. 16 is a view of a mobile cable-based power array passing over a roadway in accordance with an embodiment of the current invention;

FIG. 17A is a perspective view of a mobile cable-based power with panels tilted in accordance with an embodiment of the current invention;

FIGS. 17B and C are a schematic perspective and orthographic views of a mobile cable-based power with panels tilting system in accordance with an embodiment of the current invention;

FIG. 18 is a block diagram of a mobile power array in accordance with an embodiment of the current invention;

FIG. 19 is a schematic illustration of a mobile cable-based power array with an elevated maintenance area in accordance with an embodiment of the current invention;

FIG. 20 is a flow chart illustration of use of a mobile solar power array in accordance with an embodiment of the current invention;

FIG. 21A is a schematic illustration of a mid-grid support for a mobile cable-based power array in accordance with an embodiment of the current invention;

FIG. 21B is a schematic illustration of a mobile cable-based power array including a mid-grid support in accordance with an embodiment of the current invention;

FIG. 22 is a schematic illustration of a suspension cable support for a mobile cable-based vertical power array in accordance with an embodiment of the current invention; and

FIG. 23 is a schematic illustration of an overwater mobile cable-based power array in accordance with an embodiment of the current invention.

### DESCRIPTION OF SPECIFIC EMBODIMENTS OF THE INVENTION

The present invention in some embodiments thereof relates to a dynamic cable supported solar panel array and more particularly but not exclusively to an easy maintenance cable supported array supplying electric power.

Cable-based solar power arrays may be elevated to be suspended above ground level. In some embodiments, this property of the system allows the use of the ground beneath the solar power array for other purposes. For example, a power generating position of a solar generator may be elevated of an object (e.g., the ground and/or a body of water and/or over a building and/or over a street and/or over an outdoor recreation area). For example, the power generating position of the solar generator may be elevated over the object between 1 to 2 m and/or between 2 to 10 m and/or between 10 to 30 m and/or more than 30 m. A significant challenge to deploying cable-based solar power arrays is how to facilitate practical and cost-effective maintenance of a suspended array. Especially when the array is suspended high above the ground and/or water. For example, maintenance of solar panels may include, for example, cleaning the panels. In some embodiments, frequent cleaning may reduce loss of solar power harvesting efficiency.

Some embodiments of the present invention may include a solution to this problem. For example, the system may include a conveyer subsystem that enables the gradual lowering of parts of the solar power arrays. For example, components may be moved to a maintenance area (e.g., lowered to a ground-based maintenance location and/or moved to a suspended maintenance area) one part after the other and/or row by row for maintenance. Optionally, an entire cable-based network of solar panels moves together and each row passes to the maintenance region in turn. Optionally, at the end of the maintenance process the conveyer may reinstate the cable-based solar power array back to its previous position above the ground. Optionally, repositioning and/or maintenance is achieved without disconnecting the cable-based grid from its anchoring points and/or without losing tension in the grid and/or affecting the spread configuration of said cable-based grid above the ground.

All the descriptions and examples in this document [on all the document parts] are added to this document in order to help a man skilled in the art to understand and build said devices and apparatuses and to use an embodiment of said devices and methods and are not intended to point out a preferred embodiment or preferred uses of said devices and apparatuses.

### Overview

As used herein, the phrase “solar panel” means a panel that converts solar energy into usable power, for example electric power. Optionally, a solar panel may be from one of types known. Non-limiting examples include: flexible solar photovoltaic panels, rigid solar photovoltaic panel, silicon chip-based panels, two-sided solar panel that can harvest solar energy also coming from its back side, and/or other solar panels types].

As used herein, the term “cable” means a flexible elongated element. Optionally, the cable is from one of the types and materials known [non-limiting examples are: a wire, a rope, a cable, a chain, a bicycle type Vertebral chain and driving sprocket]. Optionally, cable materials could include metallic and/or nonmetallic [non-limiting examples for materials could include steel, polymeric materials, Kevlar, and/or other materials].

As used herein, the phrase “cable-based grid” means a lattice [for example resembling a net in its structure] made entirely or mostly of cables. The elements of the grid are not necessarily regular and/or not necessarily parallel and/or perpendicular to one another. The terms “cable-based grid” and “cable-based lattice” will be used here interchangeably. Optionally, a cable-based grid includes a plurality of net holes in its structure. In some embodiment, of a cable-based grid, some or all of the holes in the net like structure are smaller than the solar panel coupled thereto. In some embodiment, some or all of the holes in a cable-based grid are so small the net could be considered a fabric. In some embodiment of the cable-based grid some or all of the holes in the cable-based grid are bigger than a solar panel coupled thereto. For example, a plurality of solar panel may fit in one net hole. In some embodiments, the lattice may be made up of perpendicular sets of parallel cables. Alternatively or additionally, the lattice may include many angles and/or patterns. The cables may be regularly spaced and/or irregularly spaced.

In some embodiment of the present invention a solar panel may be made of or mounted on a light weight and/or shock absorbing material. Non-limiting examples of such a material include: a porous material, a fabric, a soft polymer.

As used herein, the phrase “solar panel coupling device” means a coupling device. For example, the term may include one of the types of coupling device known in previous knowledge, [non-limiting examples are: a string, a rope, a cable, screw a coupling ring, a chain, an elastic band, a spring]. A coupling device is capable of coupling a solar panel to a cable-based grid.

As used herein, the phrase “electricity collecting grid” means a network capable of collecting and convoying the electrical power created by a plurality of solar panels. The network may be from one of the types known in previous knowledge that are coupled to a cable-based grid.

As used herein, the phrase “dynamic cable length controlling device” may include a device added to an electricity collecting grid to facilitate connection to an external cable conveying electricity outside the system. The dynamic cable length controlling device may facilitate the connection having an adjustable length and/or to adjust to the position of the grid as it moves up and/or down without the connection being damaged or torn. Non-limiting examples of a dynamic cable length controlling device include apparatuses used in garden hose, apparatuses used in cranes and other systems and methods.

As used herein, the phrase “anchoring point” means an anchoring device [non-limiting examples are: a pole, a pillar, a building, a cliff, an antenna, a man-made structure, a floating anchor, a Marine anchor, the ground itself, and other anchor points].

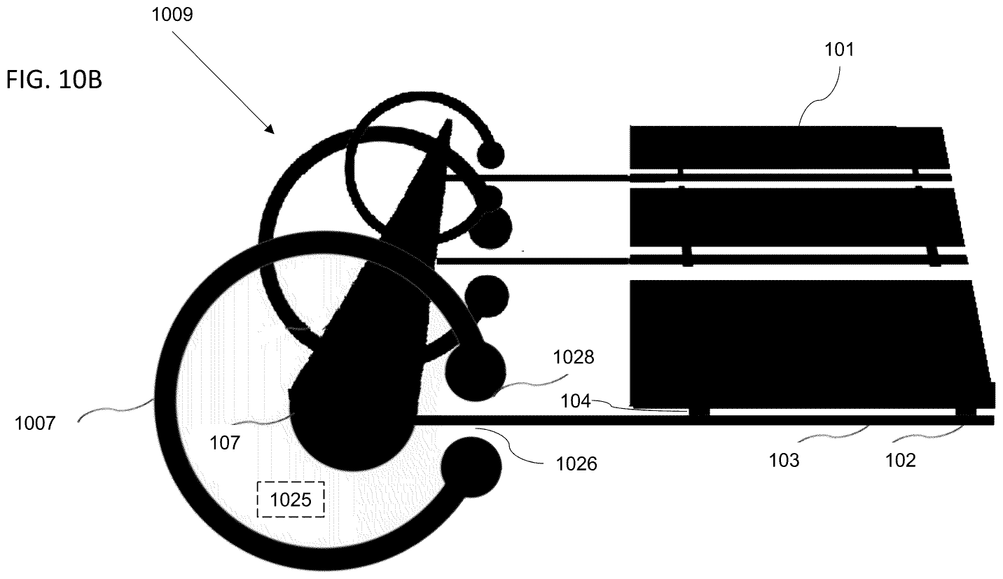

As used herein, the phrase “guiding cable” means one or a set of cables [e.g., two cables coupled to the opposite sides of a cable-based grid] that are used to guide a portion of the cable-based grid as it is conveyed. Optionally, multiple guiding cables move simultaneously and/or in a synchronized fashion. For example, various portions of the cable-based grid may be conveyed simultaneously along an area of solar collection and/or over a change in direction and/or downwards and/or upwards [for example with the help of a lowering and/or lifting apparatus for example, as illustrated in FIG. 12]. Optionally, the entire grid moves as a unit and/or a portion the cable-based grid is conveyed from its anchoring points and/or along an area of solar collection and/or over a change in direction and/or downwards and/or upwards without necessarily losing tension in the grid or affecting the spread configuration of the cable-based grid. Optionally the cable-based grid remains above the ground as it is conveyed. In some embodiment, a guiding cable includes an elongated cable along an edge of the cable-based grid and/or cables along both opposite sides of the cable-based grid. Optionally, guiding cables are located opposite sides of the flexible wired grid. The guiding cables may move the grid forward, backward, upwards and/or downwards without creating an obstruction to the horizontal cables in the structure of the cable-based grid. For example, movement of the grid may case some solar panels to move back and forth between a maintenance area and a solar exposure area.

In some embodiments, synchronization is carried out, for example, two or more motors may operate at the same time with the help of a synchronization component to drive the wheels and/or the cable itself. Alternatively or additionally, one engine may drive more than one wheel, for example, with the help of a connecting rod between the wheels In some embodiments, one motor can include a relay and/or transmission that facilitates using one motor move one or more wheel and drive different wheels simultaneously or alternately

In some embodiments, one or more motors may be detached from the system to carry out the propulsion operation from more than one location and/or to more than one solar panel system

As used herein, the phrase an “apparatus designed to reduce or increase the wind obstruction created by an embodiment of said solar panel” is a coupling apparatus enabling a reduction in the wind obstruction created by an embodiment of a solar panel. Any kind of apparatus can be used to change the wind obstruction of a panel. Two exemplary categories of apparatuses and methods that reduces an objects obstruction to the wind include: passive devices and active devices.

In some embodiments a passive devise uses the wind's own force to reduce the objects obstruction to the wind. Non-limiting examples for passive devices include:

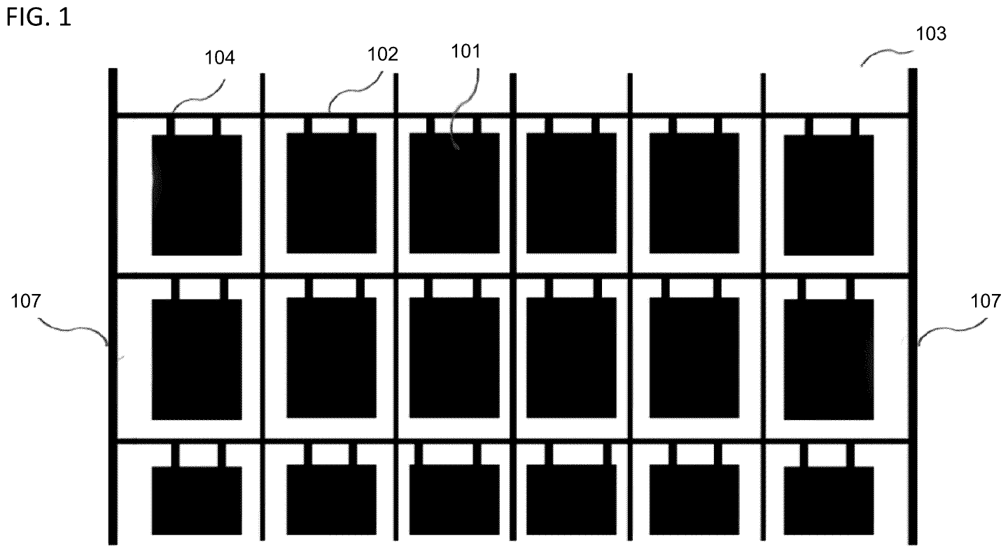

Example number 1-A solar panel (e.g., to a cable-based grid) may be couple from a first edge thereof (e.g., as illustrated in FIG. 1) while the opposing edge is allowed to move (the opposing edge could have total freedom of movement or partial freedom of movement). In some embodiments gravity would cause the panel to rotate around the first edge and/or for the opposing edge to rotate downward. An increase in wind pressure may then lift the lower part of said solar panel upwards. (e.g., resembling the way laundry is hanging from a laundry cable above it and left to swing in the wind).

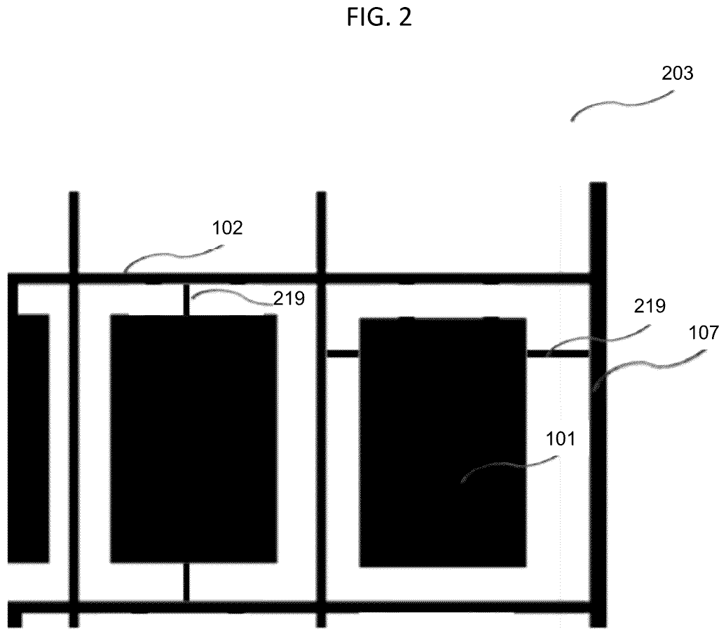

Example number 2-A solar panel may be coupled to a cable-based grid with a rotating axel type of coupling (e.g., as illustrated in FIG. 2). Optionally an increase in wind pressure would rotate the solar panel to reduce its wind obstruction properties (in a similar way to the movement of a weather vane in the wind).

Example number 3-A solar panel may be coupled to a cable-based grid with an elastic component that expands or extends when wind pressure increases (non-limiting examples are a rubber band, a spring and other elastic connecting objects)

The second category is: active devices that have their own power source (from one of the types of power sources known in previous knowledge, non-limiting examples are: an electric motor, a fuel-based engine, man power). And this power source gives them the power to react to information coming from a sensor (non-limiting examples are sensors gathering information about wind speed, the direction of the wind, the tension in a cable) and said active devises based on said information can modify the degree of the wind obstruction created by the solar panel.

Non-limiting examples of active devises to reduce wind obstruction of a solar panel include:

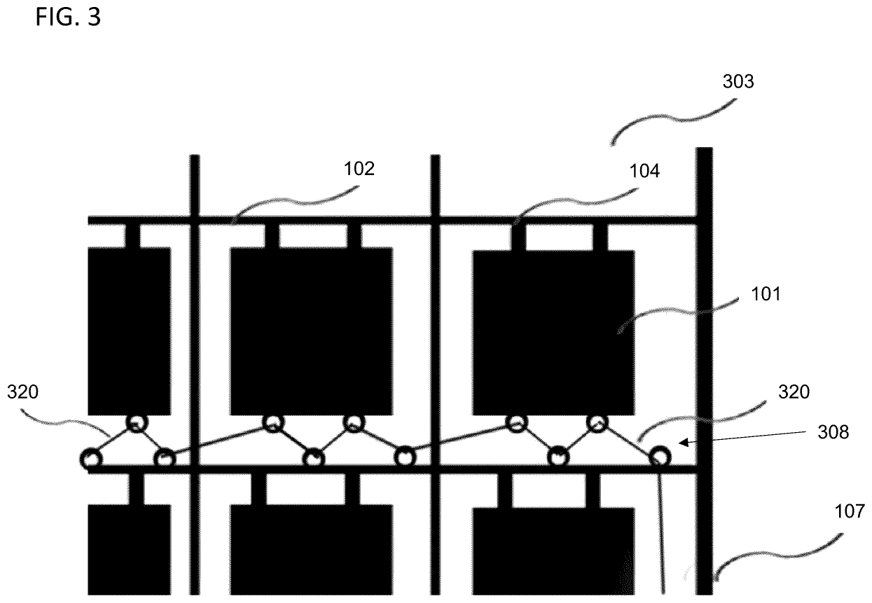

Example number 1—An active wind obstruction reducing device may include a tension controlling device (e.g., a tensioning cable e.g., as illustrated by cable of FIG. 3). For example, the tension cable may couple a solar panel to a cable-based grid in a way that tightening the tensioning cable determines the degree of freedom of movement of a solar panel. For example, as the tensioning cable is loosened, more freedom of movement is granted to the portion of the solar panel. For example, as the tensioning cable is tightened the degree of freedom of the free end of the solar panel is reduced (e.g., similar to a shoelace) (e.g., as illustrated in FIG. 3). In some embodiments, a tensioning cable may be used to control an angle of the solar panel to the sun. For example, when the sun is at a low angle, the solar panel may be tilted towards the sun, for example, by reducing tension of the tensioning cable and/or allowing the free end of the panel to drop under gravity. Optionally, the free end of multiple panels may be interconnected (for example by a bar and/or cables e.g., such that rotation of the panels is synchronized). In some embodiments, a weight may be added to the free end of a panel. For example, the weight may dampen flutter of the panel in wind and/or keep the panel at a selected angle towards the sun. Optionally, a tilting system may fix the angle of the panel.

Example number 2-A surface reducing apparatus may be coupled to a solar panel and/or react to information about the wind to reduce and/or increase exposure of the surface of said solar panel to wind. For example, a processor may receive information on wind speed and/or direction and/or adjust an angle of a panel (e.g., with angling mechanisms as described herein and/or other mechanisms). Non limiting examples of a system that fixes an angle of a panel and/or a method do so include: surface reducing systems and methods similar to those used in window blinds and/or garage doors and\or motorized sun-trackers for solar panels and/or other types of trackers and/or actuators. The angling of panels may be connected to movement of the cable-based grid and/or independent of the position of the grid.

As used herein, the phrase “conveying apparatuses” means an apparatus that is designed to drive and/or to guide a cable-based grid. For example, conveying apparatus may drive and/or guide a guiding cable along a predetermined path. Optionally, the structure of the conveying apparatus facilitates objects coupled to the guiding cable to move in the same direction as the guiding cable, without creating an obstruction. Optionally, a conveying apparatus includes a cable pulley.

In some embodiments of the present invention there are a plurality of motors coupled to a cable-based grid. Optionally, the movement of the motors is synchronized by a synchronization device.

In some embodiments a conveying apparatus includes a cable guide. A cable guide as used herein is a device coupled to a guiding cable in a way that leads to movement of the cable in a desired path without obstructing the movement of other parts of the cable-based grid. For example, the cable guide may guide a guide cable and/or the cable-based grid may move in the same direction as the guiding cable. For example, a cable guide may include a guide wheel, a guide sprocket, a guide channel and/or a set of guide rings. In some embodiment of the present invention a cable guide may be used to create a complex movement path of an embodiment of a cable-based grid

In some embodiments, conveying apparatuses use different methodologies to move a cable (whereas the cable is coupled to other objects) in one direction without obstructing the objects coupled to the cable to move in the same direction. For example, a conveying apparatus may include different sized drive wheels to collect up the guide cable and/to guide the guide cable as the cable traverses different radius curvature bends, a conveying apparatus may include different sized drive wheels and/or gears to collect up and/or drive the guide cable and/or to drive and guide the wire based grid as the cable and grid traverse different radius curvature bends and/or the conveying apparatus may use a guide channel confining and/or limiting movement of one or both of the guide cable and/or the cable-based grid. The Channel may include a mechanism (for example, a slit) that allows some cables [for example cables coupled to the guiding cable] freedom to move in and out of the channel.

In some embodiment of the present invention a Vibration canceling device may be integrated as a component in the solar panel array and/or the cable-based grid and/or the conveying apparatus.

In some embodiment of the present invention an electricity storage device may be integrated as a component in the system.

In some embodiments a suspended and/or cable-based solar array may include a safety device. For example, the safety device may inhibit collateral damage from broken and/or disconnected components of the support structure and/or cables. Non limiting examples include: failsafe cords coupled to an element in the solar panel array (for example, to prevent the array and/or parts thereof from falling down in case of detachment) and/or nets integrated into the system in a way that intercepts falling parts of the system that may become detached and/or other safety devices.

### Description of Specific Embodiments of the Invention

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

FIG. 1 is a schematic illustration of a cable-based grid 103 in accordance with an embodiment of the current invention. In some embodiments, one or more solar panels are attached to a lattice of cables 102. Optionally the lattice includes a grid [resembling a net in its structure made entirely or mostly of cables 102 and has a plurality of net holes in its structure. In some embodiments, the holes in the net like structure are bigger than the solar panels 101 coupled to it. Optionally one or a plurality of solar panel may fit in one net hole. Alternatively or additionally, the holes in the net like structure are smaller than the solar panels coupled to it. Alternatively or additionally, the holes in the net like structure are so small the net could be considered a fabric.

In some embodiments, the cables 102 and/or connectors 104 a solar panel coupling device couple a solar panel 101 to the cable-based grid 103 include electrically conductive cable and/or power converters. Electrical power is optionally conducted from the solar panels 101 to an electricity collecting grid, for example, including a grid capable of collecting and convoying the electrical power created by a plurality of solar panels 101. Optionally, the electricity collecting grid includes one or more power converters.

In some embodiments, a cable-based grid 103 is connected to a set of guiding cables 107. For example, two guiding cables 107 are coupled to the opposite sides of cable-based grid 103. and are used simultaneously to guide and/or convey the cable-based grid 103 along a predetermined path.

In some embodiments, a portion of the solar panels may free to move (e.g., by force of wind or gravity). For example, a first (upper) side of a solar panels 101 may be coupled by coupling 104 to cables 102 of the cable-based grid 103. Optionally, the opposing side [lower part] of the solar panels 101 are free to move with the wind and/or gravity.

In some embodiments, the changing angle of solar panels may serve as a passive wind blocking apparatus. For example, as illustrated in FIG. 1, a solar panel 101 may be coupled to a cable-based grid 103 from one edge while a second edge is not restricted in its movements (the second edge could have total freedom of movement or partial freedom of movement). For example, an increase in wind pressure would lift the second edge of the solar panel upwards (e.g., similar to the way laundry hangs from a laundry cable and/or swings in the wind). An example of such a configuration is illustrated in FIG. 1. For example, panels 101 are connected on one side to a supporting cable 102 by couplings 104. The opposite side of the panels is free and may hang down under gravity and/or be blown up and down by the wind.

FIG. 2 is a schematic illustration of a cable-based grid 203 including a rotating axel type of coupling 219 in accordance with an embodiment of the current invention.

In some embodiment a cable-based grid 103 is coupled to anchor points in a way that elevates the flexible wired grid 103 above the ground level and/or water surface in a configuration that could be for example, horizontal, vertical, arched and/or sloping.

In some embodiments, a solar panel is coupled a cable-based grid 103 with a solar panel coupling device.

In some embodiment of the present invention the net holes in the cable-based grid are bigger than the size of the solar panel 101. For example, the solar panel 101 is coupled to the cable-based grid 103 inside a net hole that is bigger than the panel 101 and/or the cables 102 creating the net hole totally and/or mostly do not obstruct movements of the solar panel 101.

In some embodiment of the present invention the net holes the cable-based grid are smaller than the size of the solar panel and/or the solar panel is coupled to the cable-based grid lying on top of the cable-based grid and/or under it.

An exemplary passive wind apparatus to reduce wind resistance of solar panels is illustrated in FIG. 2, in accordance with an embodiment of the current invention. For example, a solar panel 101 is attached to a cable-based grid 103 with a rotating axel type of coupling 219. Optionally, an increase in wind pressure would rotate the solar panel 101 to reduce its wind obstruction properties (e.g., in a similar way to the movement of a weather vane in the wind).

In some embodiments, an active device includes an actuator (non-limiting examples are an electric motor, a fuel-based engine, man power). Optionally, the power source reacts to information coming from a sensor (non-limiting examples are sensors include various sensor that gather information about wind speed, the direction of the wind, the tension in a cable) and/or the active devise reacts to information from the sensor to modify the orientation of the solar panel to the wind and/or the position of the solar panel to modify the degree of the wind obstruction created by the solar panel.

FIG. 3 is a schematic illustration of an apparatus 308 designed to adjust an angle of a solar panel 101 in accordance with an embodiment of the current invention. For example, adjusting the angle may reduce or increase the wind obstruction created the solar panel 101 in a cable-based grid 303. Some embodiments of an angle adjusting apparatus 308 include an active type adjustment. For example, apparatus 308 includes a tension controlling device for example, a tightening cable 320.

An example of an active devises to reduce wind obstruction is illustrated in FIG. 3, in accordance with an embodiment of the current invention. An active devise to reduce wind obstruction may include a tightening cable 320 that couples a free edge of solar panel 101 to a cable-based grid 103 in a way that the slack on cable 320 determines the degree of freedom of movement of free edge of the solar panel 101. When the slack on the cable 320 is increased (e.g., by increasing length of the cable 320), more freedom of movement is granted to the free edge of the panel 101. When slack on the cable 320 is reduced (e.g., by shortening the cable 320) the tighter cable becomes (e.g., less slack) the compelling becomes stronger and/or the degree of freedom to the free end of the solar panel 101 is reduced. For example, this is similar to a shoelace, and/or similar how shoe laces work.

A second example of an active devises to reduce wind obstruction may reduce or increase the exposed surface of a solar panel in response to a sensor (for example, sensing wind speed and/or direction). Non limiting examples for such a device or a method are: the surface reducing systems and methods used in window blinds (e.g., stacking panels together to reduce exposed area) or garage doors (e.g., moving panels to a shielded position). Using other surface reducing systems and methods may be used.

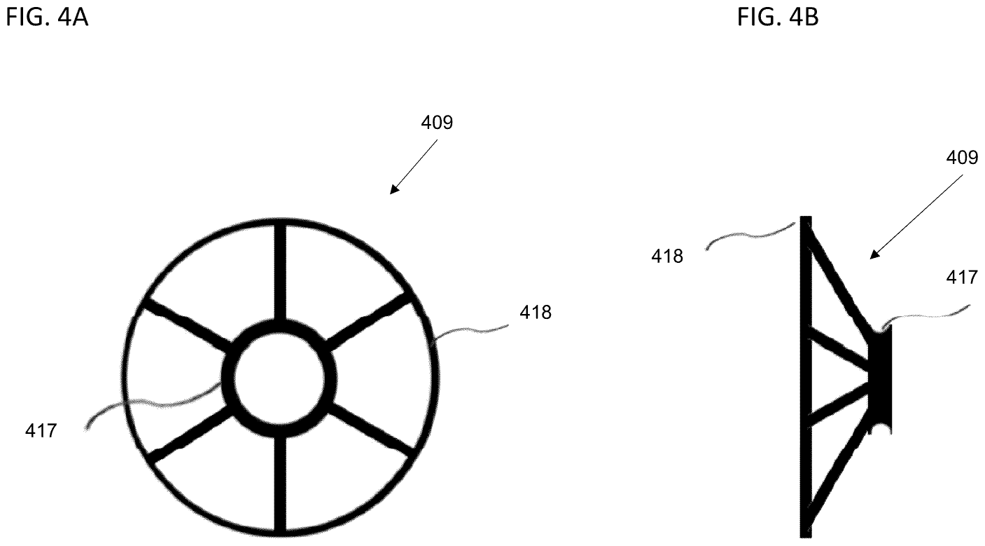

FIGS. 4A and 4B are schematic side and rear views of a cable guide 409 in accordance with an embodiment of the current invention. FIG. 4C is a schematic side view of a cable guide 409 and a tensioning device 413 in accordance with an embodiment of the current invention. In some embodiments a conveying apparatus may include a conveying reel 417 and a rotating curve guide 418. For example, the conveying reel 417 may drive a guide cable while the rotating curve guide 418 defines a curve over which the cable coveys a flexible solar array.

In some embodiments, cable guide 409 may be mounted on a tensioning device 413. For example, the cable guide 409 may include an actuator (e.g., a pneumatic piston 414 that pulls on the cable guide 409 and/or a cable. For example, cable guide 409 may be mounted to an anchor point 406 an arm 436 and/or a pivot 437. Optionally, cable guide 409 is attached to arm 436 via a bearing 438.

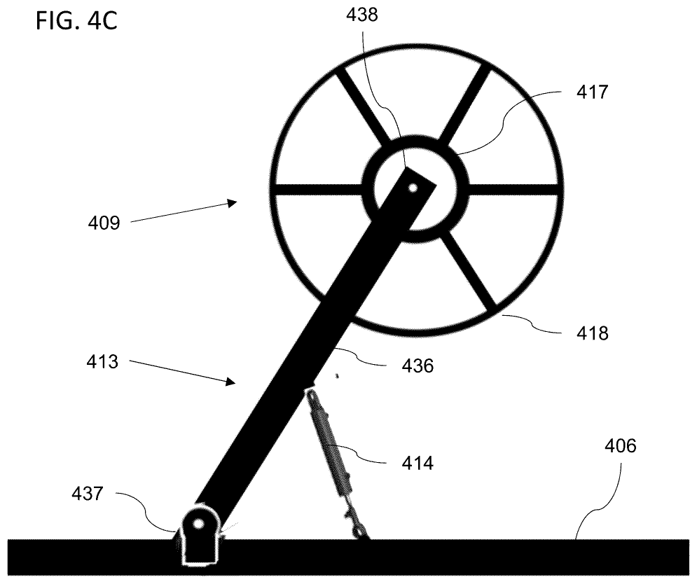

FIG. 5 is a schematic illustrating of cable guide 409 being used to roll a cable-based grid (e.g., grid 103) forward and/or backward around a direction change without losing the tension in the cable-based grid in accordance with an embodiment of the current invention. In some embodiments, the cable-based grid 103 and/or guiding cable 107 are conveyed in a manner similar to a conveyer belt and/or a cable of a cable car and/or ski lift. Optionally, various geometry drivers (components, take-up reels and guides) may be used for various portions of a guide cable and/or cable-based grid to drive the cable and/or grid over different radius direction changes while preserving tension on cables.

In some embodiments, a cable guide 409 includes components to drive panels 101 along a path that has significantly different diameters of curvature in deferent areas in its structure. In some embodiments, the cable guide 409 drives the guiding cable 107. Optionally, the guiding cable 107 is coupled to the device in a tight fit around a component with a smaller diameter conveying reel 417 while the other parts of the cable-based grid 103 move in the same direction around a portion of a path with a larger radius of curvature are wrapped around a larger diameter wheel curve guide 418 of the cable guide 409. Optionally, the tight fit of the guiding cable 107 inhibits the guiding cable 107 from sliding off the small diameter conveying reel 417 despite the pulling force created by movement of the cable-based grid 103 around curves with different radius of curvature.

In some embodiments, the tension in the cable-based grid 103 is kept consistent by using two of cable guide 409 each at the opposite sides of the cable-based grid 103. Optionally, the cable guide 409 is configured in a way that the component with the smaller diameter conveying reel 417 is facing away from the cable-based grid 103 and as the two guiding cables 107 on opposite sides of the cable-based grid 103 are guided tightly around them. Optionally, the grid 103 itself is stretched between the two guiding cables and around the rotating curve guide 418 with the bigger dimeter in the cable guide 409.

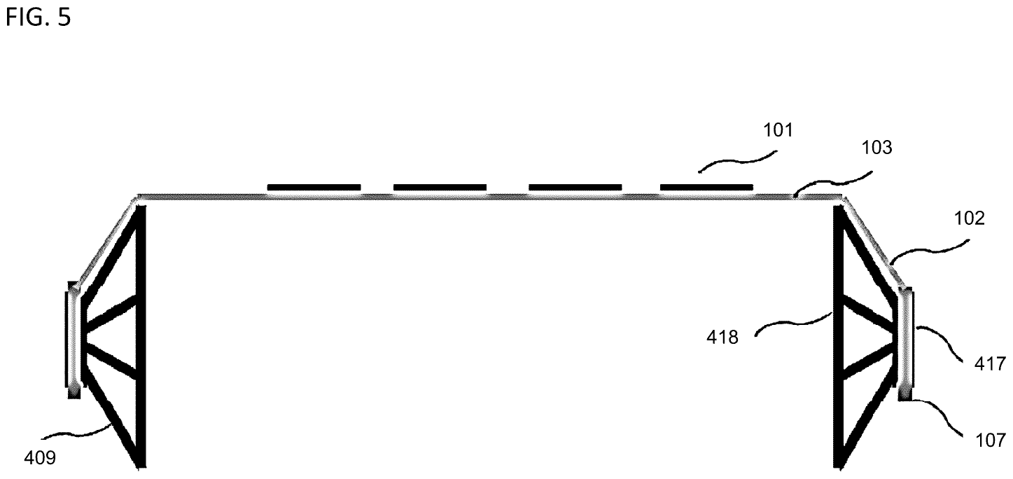

FIGS. 6A and 6B are schematic side and rear views of a cable guide 609 in accordance with an embodiment of the current invention.

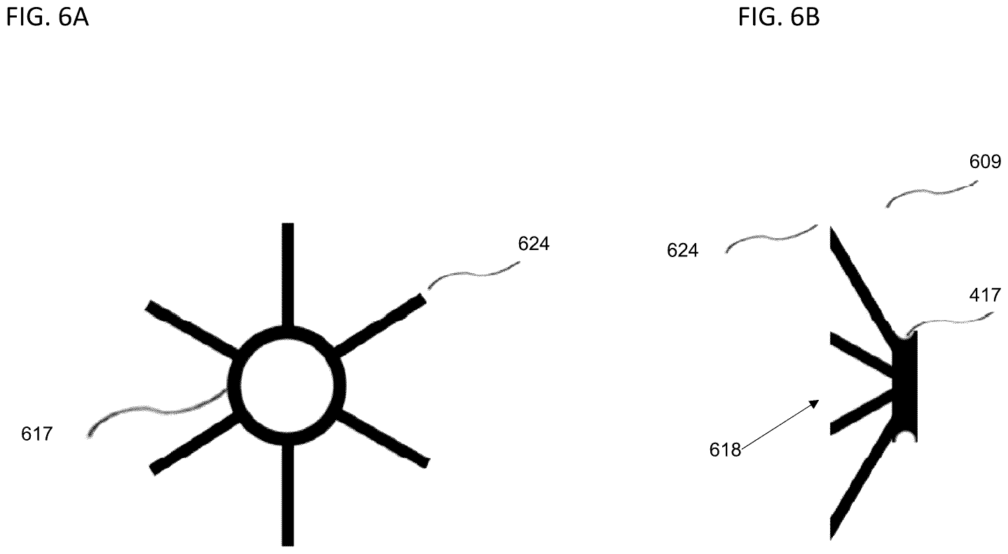

FIG. 7 is a schematic rear view of cable guide 609 being used to roll a cable-based grid (e.g., grid 103) around a direction change without losing the tension in the cable-based grid in accordance with an embodiment of the current invention.

In some embodiments, a cable guide 609 that has a small diameter component conveying reel 617 having a structure configured to drive and/or reel up a guiding cable 107. Additional or alternatively, cable guide 609 has a large diameter guide sprocket 618 having a structure configured to drive the cable-based grid 103. For example, the component may include a plurality of protruding teeth 624 around it Optionally, guiding cable 107 is coupled to the small diameter conveying reel 617. Optionally, the cable-based grids connect around the guide sprocket 618 in a way that directs it to move around it and the horizontal cables 102 of the cable-based grid 103 are integrated between the protruding teeth 624 as they move in the same direction, and the tension in the cable-based grid 103 is kept by using the cable guide 609 with protruding teeth 624 each at the opposite sides of the cable-based grid 103. Optionally, conveying apparatus is configured in a way that the smaller diameter reel 617 is facing away from the cable-based grid 107 and the guiding cables 107 at the opposite sides of the cable-based grid 103 are guided tightly around them. Additionally, or alternatively, the horizontal cables in the cable-based grid 103 is driven interwoven between the protruding teeth 624.

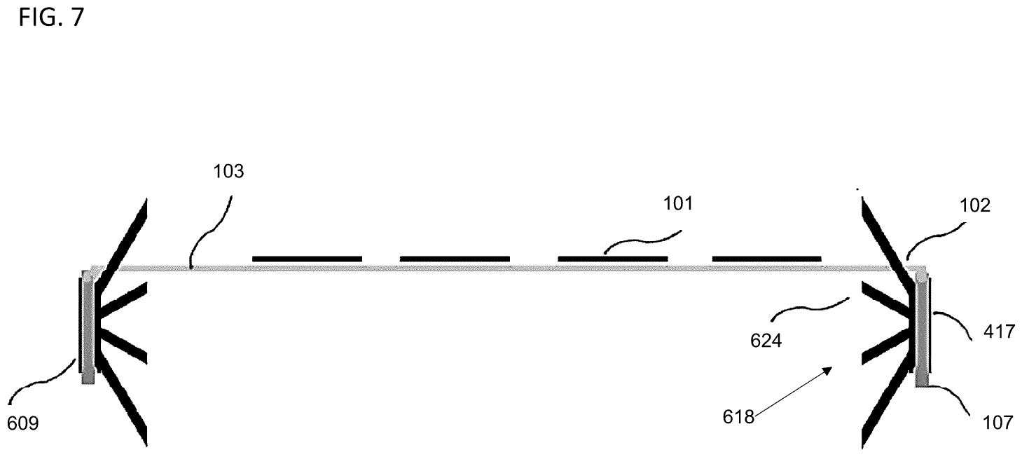

FIG. 8 is a schematic illustrating of a sprocketed cable guide 809 being used to convey cable-based grid 103 in accordance with an embodiment of the current invention. In some embodiments, conveying apparatuses includes a sprocketed cable guide 809 resembling a bicycle transmission and/or may be used to convey a cable-based grid (e.g., grid 103) without losing the tension in the cable-based grid. Optionally, a guiding cable 807 includes a chain driving by sprocketed cable guide 809.

In some embodiments, a conveying apparatus may drive a chain 807 (e.g., similar to a bicycle chain) and a rotating sprocketed cable guide 809 with protruding teeth also similar to the one in bicycle gear.

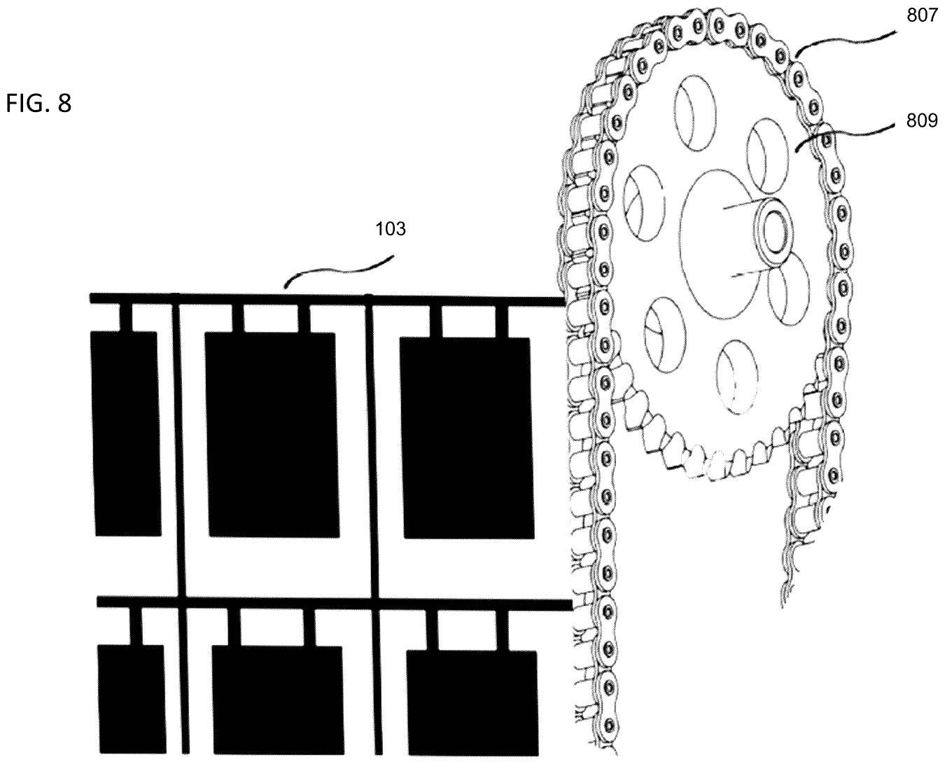

FIG. 9 is a schematic cross-sectional illustration of a cable guide channel 909 with an internal channel (e.g., channel 925) and a side slit 926 in accordance with an embodiment of the current invention. For example, cable guide channel 909 could be used to guide a cable-based grid (e.g., grid 103) as it is conveyed without losing the tension in the cable-based grid.

In some embodiments, the cable guide channel 909 constrains guiding cable 107 to follow the shape of its internal channel. For example, when cable guiding channel 909 is shaped like the letter “U” the guiding cable 107 moving inside the channel 925 will make a U-turn as it is conveyed along the channel. Note in the exemplary embodiment, guiding cable 107 is thicker than cables 102 of cable-based grid 103 such that guiding cable 107 does not pass through slit 926 and remains inside the channel of the guide while cable 102 passing through the slit 926 and holds cable 107 to the grid.

In some embodiments, a cable guide channel 909 includes an internal channel 925. Optionally, the cavity includes a side slit 926. For example, a guiding cable 107 moves inside the channel 925 while the other parts (e.g., cables 102) of the cable-based grid 103 are coupled to the guiding cable 107 and moving in the same direction as the guiding cable 107. Optionally, the side slit 926 is narrower than the dimeter of the guiding cable 107 such that the guiding cable 107 is retained inside the channel 925. Optionally, cables 102 in the cable-based grid 103 and/or coupled to the guiding cable 107 are narrower than the slit 926 and/or slide freely through the slit 926 uninterrupted.

In some embodiment of the present invention a friction reducing device (e.g., bearings are added to a conveying apparatus and/or a cable guide channel 909 in a way that reduces the friction created by the movement a guiding cable 107 and/or cable-based grid 103. In some embodiments, a friction reducing device may be positioned inside the channel 925 of an embodiment of the cable guide channel 909 and/or in a side slit 926 thereof and/or at the entry or exit point of the guiding apparatus, and/or at the narrow part of the slit, channel and/or a gap in the structure. Non limiting examples for a friction reducing device include: friction reducing beads (optionally mounted on the guiding cable 107, a Ball Bearing integrated into the structure of the conveying apparatuses and/or a Conveyor Bearing integrated into the structure of the conveying apparatuses, and/or other types of Bearings.

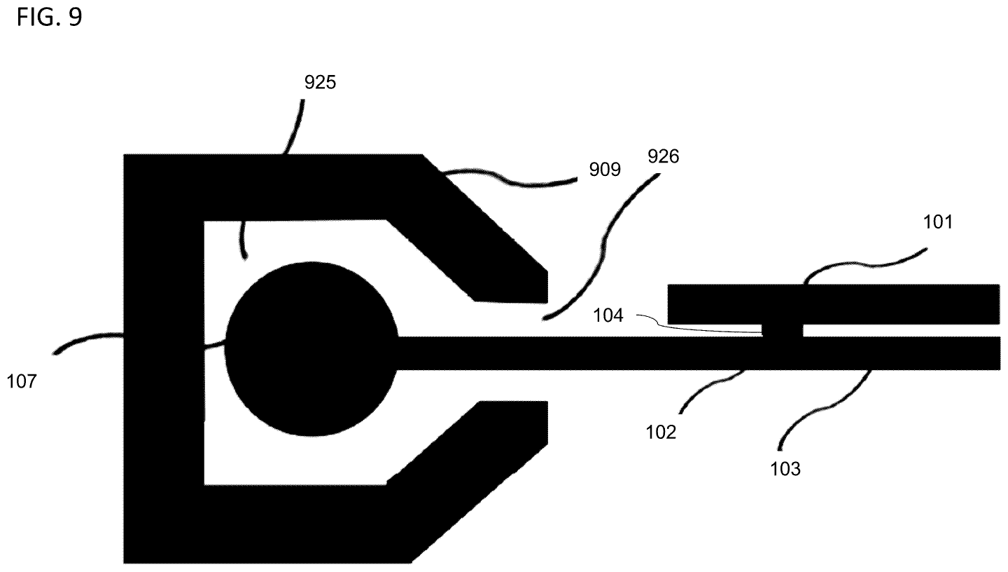

FIG. 10 is a schematic cross-sectional illustration of a cable guide including a series of open rings in accordance with an embodiment of the current invention. In some embodiments, a cable guide 1009 which channels in a series of internal spaces 1025 in a series spaced out rings 1007 and/or a synchronized series of aligned gaps 1026 in the rings in accordance with an embodiment of the current invention. For example, cable guide 1009 could be used to guide a cable-based grid (e.g., grid 103) while it is conveyed without losing the tension in the cable-based grid.

In some embodiments, the cable guide 1009 constrains guiding cable 107 to follow the series of 1025 of a series of rings. For example, when rings 1007 are deployed like the letter “U” the guiding cable 107 moving inside the internal spaces 1025 will make a U-turn as it is conveyed along the internal spaces 1025. Note in the exemplary embodiment, guiding cable 107 is thicker than cables 102 of cable-based grid 103 such that guiding cable 107 does not pass-through gaps 1026 while cable 102 docs. Optionally, the cable guide 1009 may a friction reducing element 1028 in or near the gap 1026. For example, the friction reducing element 1028 may include bearings (e.g., ball bearings, roller bearings etc.) along the edge of gap 1026. The bearings may reduce friction as cables 102 slide along the gaps 1026.

In some embodiments, an array of a plurality of separate ring-like apparatuses 1007 with a gap 1026 in their structure serve as a guiding apparatus with internal channel made up of the internal spaces 1025 of the rings 1007. Optionally a guiding cable 107 moves inside the inner side spaces 1025 of the rings (which forms a sort of discontinuous channel). Optionally, other parts of the cable-based grid 103 are coupled to the guiding cable 107 and/or moving through a series of gaps in the structure of the array of rings 1007.

It is understood that a channel (which may be continuous or discontinuous) formed by a line of such rings conducts the guiding cable 107 to follow along the shape created by the series of rings. For example, when the series of rings are aligned in in a configuration similar to the letter “U” the guiding cable 107 moves inside the series of the rings and makes a U-turn as it is conveyed.

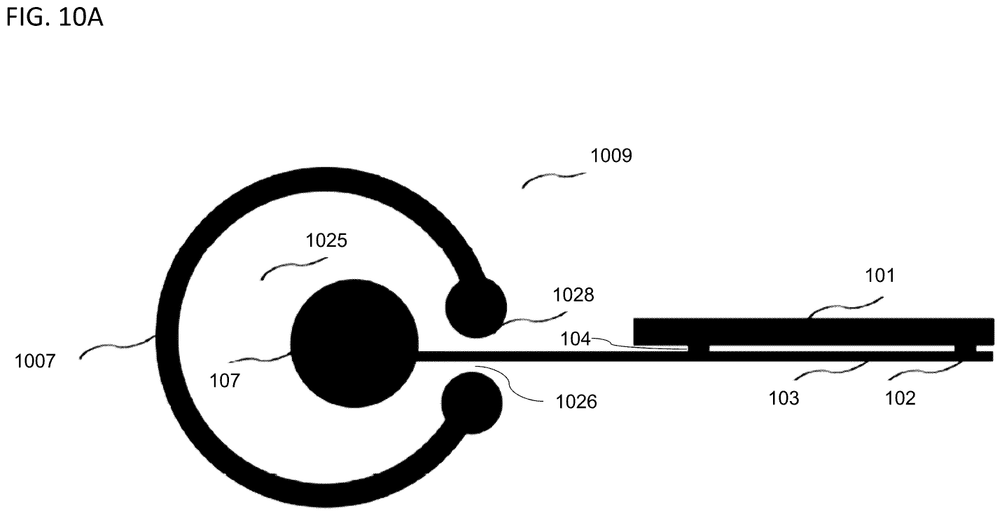

FIG. 11 is a schematic illustration of an embodiment of a dynamic tension creating device maintaining tension on a lattice of cables 1102 (e.g., cable-based grid 103) in accordance with an embodiment of the current invention. For example, one or more actuators (e.g., pneumatic pistons 1114) apply a force (e.g., pulling force) that preserve a predetermined tension on the lattice of cables 1102 (e.g., cable-based grid 103). For example, pistons 1114 connect between cable guide 409 and an anchor point 1106. Alternatively or additionally, a dynamic tension creating device may include a tension wheel. Optionally, a dynamic tension creating actuator may include a mechanical actuator (e.g., a screw driven element) and/or an elastic element (e.g., a spring) and/or a hydraulic element (e.g., a hydraulic piston) and/or a pneumatic element.

FIG. 11 also illustrates an embodiment of a reflective surface 1115 enhances solar energy absorption by solar panels 101. For Example, a reflective surface 1115 may reflect sunlight onto panels on a rear side of a conveyer.

Alternatively or additionally, surface 1115 may include a safety component that prevents objects from falling from the suspended solar energy system to the ground below. For example, surface 1115 may include a net that catches fragments falling from and/or disconnected from the suspended system.

In some embodiments, reflective surface 1115 includes a reflective device made of light weight flexible material [non limiting examples include: a net, a Fabric, a grid, a sheet made of polymeric material etc.]. Optionally, the light weight flexible material has a high albedo [for example, its color is white or metallic silver].

In some embodiments of the reflective surface 1115 includes a plurality of elements with high albedo coupled to the flexible material.

In some embodiments of the present invention a reflective surface 1115 is coupled to a flexible wire grid 1103 [e.g., directly and/or through other components] in a way that reflects sun rays back to the back side of the solar panels 101, e.g., facilitating more efficient absorption of the sun energy for a two-sided solar panel.

FIG. 11 also illustrates an embodiment of a solar panel cooling device 1113. could be integrated into the solar energy array. For example, at a certain location, at a few locations and/or all along a solar collecting device, nozzles may spray water and/or a mist onto solar panels 101.

In some embodiments, a solar array may include a cleaning device 1111. For example, cleaning device may include a stationary device that may cover a line across a cleaning section and/or clean solar panels of a whole row together and or the rows of solar cells may be conveyed to the cleaning location. Alternatively or additionally, the cleaning device may be mobile and/or pass across the panels.

Some embodiments, may include a dynamic tension creating device for a cable-based grid 1103. For example, tensioning device may include a device capable of enhancing and/or reliving the tension in a guiding cable 107 and/or a cable 1102 in the cable-based grid 1103. For example, the tension enhancing device may include a pneumatic piston 1114.

A non-limiting example of a tensioning device includes a hydraulic arm 1114 coupled on one side to a cable guide 409 and/or on its other side to an anchoring point 1106. For example, the tensioning device 1133 may include an actuator (e.g., a pneumatic piston 1114 that pulls on the cable guide 409 and/or a cable. For example, cable guide 409 may be mounted to an anchor point 1106 an arm 1136 and/or a pivot 1137. Optionally, cable guide 409 is attached to arm 1136 via a bearing 1138.

For example, the coupling is executed in a way that as the tensioning device (e.g., piston 1114) contracts and/or the length of the hydraulic arm is shortened, tension is increased in the cables stretched between opposing cable guide 409. In some embodiments, the dynamic tension creating device is configured to enhancing tension in a cable spaced grid 1103 and/or guiding cable 107 (e.g., increasing and/or decreasing the tension according to need (e.g., in response to a sensor)).

In some embodiments, a solar power array may include any combination of none, one, some and/or all of a cleaning device 1111, a reflective surface 1115 and/or a cooling device 1133.

In some embodiments, a cable-based grid 1103 that has a relatively small holes in its structure or even a Fabrice type structure. Optionally a small diameter conveying reel 417 pulls on the guide cable and/or cables 102 while curve guide 418 (e.g., a high friction guide wheel) pushes the cable-based grid 1103 over direction changes (e.g., downwards and/or upwards via the fabric).

In some embodiments, the tension in the grid is kept by using a tension maintaining device on each side of the cable-based grid 1103.

In the embodiment a mobile solar power array includes an apparatus to reduce or increase the wind obstruction. Optionally, the apparatus to reduce or increase the wind obstruction could be from the passive type and/or the active type

In some embodiment of the present invention a solar panel cleaning device 1111 may be added as a subsystem to a mobile solar panel array. For example, the solar panel cleaning device 1111 may be stationary. Optionally, the solar array is moved. For example, a cable-based grid 103 may move to pass attached solar panels 101 gradually under the cleaning device 1111 and/or to be cleaned. Alternatively or additionally, the cleaning device 1111 may be mobile across a maintenance area. For example, a sub-set of solar panels may be moved to the maintenance area and/or the cleaning device passed over the maintenance area to clean sub-set of the panels in the maintenance area. Subsequently a new sub-set of panels may be moved to the maintenance area and cleaned. Alternatively or additionally, the cleaning device 1111 may be mobile over the entire array.

In some embodiment of the present cable guide 409 and/or a similar device may be coupled to the solar panel cleaning device 1111. Alternatively or additionally, the same cable guide 409 and/or a different mobilizing device may be integrated as a subsystem in, and/or coupled to, the cable-based grid 1103 and/or solar panel array (e.g., to mobilize the solar array).

In some embodiment the solar panel cooling device 1111 is integrated as a subsystem in, or coupled to, the cable solar panel array.

In some embodiment of the present invention a layer of absorbing material is added to the back side of at least one solar panel to facilitate continued cooling after water is applied. For example, water may be applied on the back side of the solar panel and/or cool the heat absorbing material. Optionally the heat absorbing material (for example an aluminum block) will continue to cool the solar panel even after the water has dried. Optionally the water retaining material (for example and absorbent material) that will remain wet and/or continue to cool the solar panel. In some embodiment of the present invention both cleaning and cooling is done by the same system.

In some embodiments a suspended and/or cable-based solar array may include a safety device. For example, the safety device may inhibit collateral damage from broken and/or disconnected components of the support structure and/or cables. Non limiting examples include: failsafe cords coupled to an element in the solar panel array (for example, to prevent the array and/or parts thereof from falling down in case of detachment) and/or nets integrated into the system in a way that intercepts falling parts of the system that may become detached and/or other safety devices. For example, a flexible base 449 connects conveyer assembly

FIG. 12 is a side view of a cable guide 1209 having a complex path for guiding a guiding cable 1207 to drive a cable-based grid along the path in a solar power array 1208 in accordance with an embodiment of the current invention. In some embodiments, a solar array may include a wind blocking device. For example, wind blocking apparatus 1232 is integrated into the exemplary system of FIG. 12.

In some embodiments, a solar power array may include a wind blocking apparatus 1232. For example, apparatus 1232 is designed to reduce or increase the wind obstruction created by a solar panel array (for example, including (a cable-based grid and/or multiple solar panels and/or a conveying device for example, as illustrated in various embodiments herein). For example, apparatus 1232 is wind blocking apparatus. Optionally a sail and/or a wall shields a solar array 1208 from wind.

In some embodiment of the present invention an embodiment of an apparatus 1232 designed to reduce or increase the wind obstruction is integrated as a subsystem in, and/or coupled to, the cable-based grid 1203, and/or an anchor point 1106. For example, there may be a wind redirecting element such as sail and/or wall and/or fin. Optionally apparatus 1232 enables reduction in the wind obstruction created by solar power array 1208 and/or from another solar power apparatus.

In some embodiment of the present invention a wind blocking apparatus 1232 is coupled to and/or erected near a solar collecting array in a configuration that reduces the impact of wind currents on the solar panel array.

In some embodiment of the present invention a solar collecting array 1208 is elevated above the ground. Optionally, a cable guide 1209 and/or guide conveys solar panels from the array between a location where they are exposed to sunlight to a location facilitating maintenance of the panels, (e.g., near the ground and/or near an elevated maintenance area etc.). Optionally, the cable guide 1209 and/or to one or more anchor points 1106. Optionally, the guide, cable guide 1209 and/or anchor point 1106 is coupled to one or more devices in a way that creates a Dual Use of the same land area. In some embodiments, the device may use the electricity produced by the elevated above ground solar panel array or alternatively, the device may not use the power produced by the array.

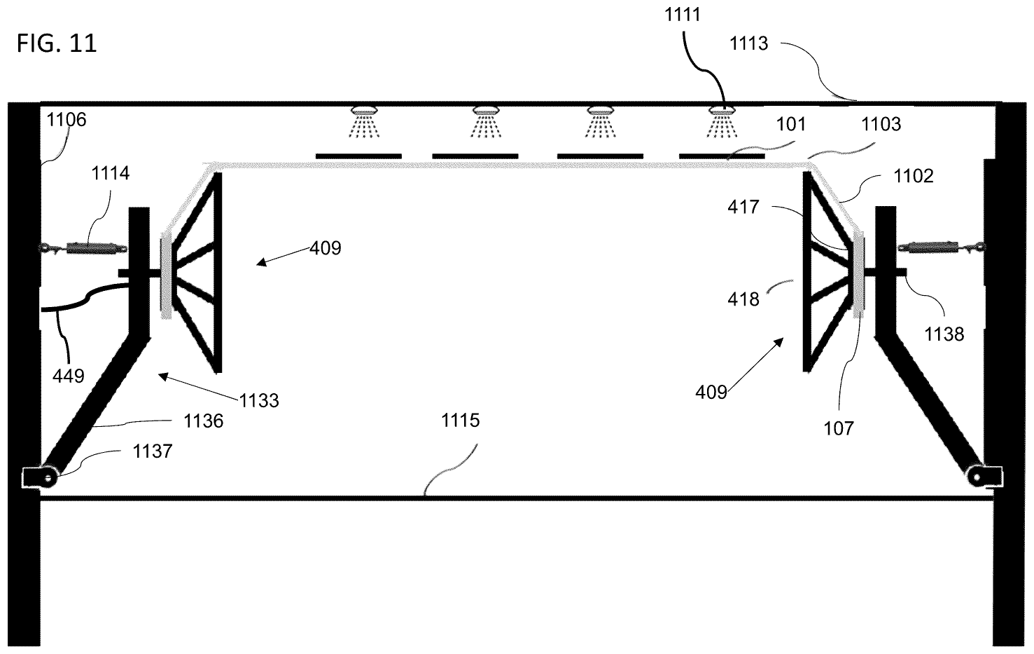

FIG. 13 is a schematic illustration of a dynamic cable length controlling device 1330 in accordance with an embodiment of the current invention. In some embodiment, a solar collecting array (e.g., a plurality of solar panels connected to a cable-based grid) moves (e.g., between a position collecting power to a position for cleaning and/or maintenance). Optionally, a connection to an electricity collecting network 1305 includes an adjustable length cable 1331 with a first immobile end 1333 connected to the electrical network 1305 (e.g., to facilitate conveying the electricity outside the system) and a second movable connection 1334 connected to the solar collecting array (e.g., a cable-based grid and/or plurality of solar panels). The adjustable cable 1331 may be suitable to facilitate repositioning of the cable-based grid and/or solar panels (e.g., as it moves up or down) without the connecting cable 1331 being damaged or torn. Non-limiting examples for an adjustable cable length controlling device include apparatuses used in garden hose, apparatuses used in cranes and other systems.

In some embodiments, an electrical adaptor 1336 (e.g., a transformer, DC to DC converter, a DC to AC converter, an AC to DC converter, a pulse width modulation (PWM) based adapter etc. may facilitate transferring power between the solar panel array and the grid power. Alternatively or additionally, and electrical adapter and/or converter may be placed within the solar panel array (e.g., to increase efficiency and/or protect panels from burn out, to control voltage, to control current etc.). The system may also include components to control oscillation of power, for example, a voltage asymmetry monitoring and/or controlling device (e.g., a sensor, an asymmetric voltage axis and/or an energy storage element (e.g., a capacitor and/or battery) and/or an inductor.

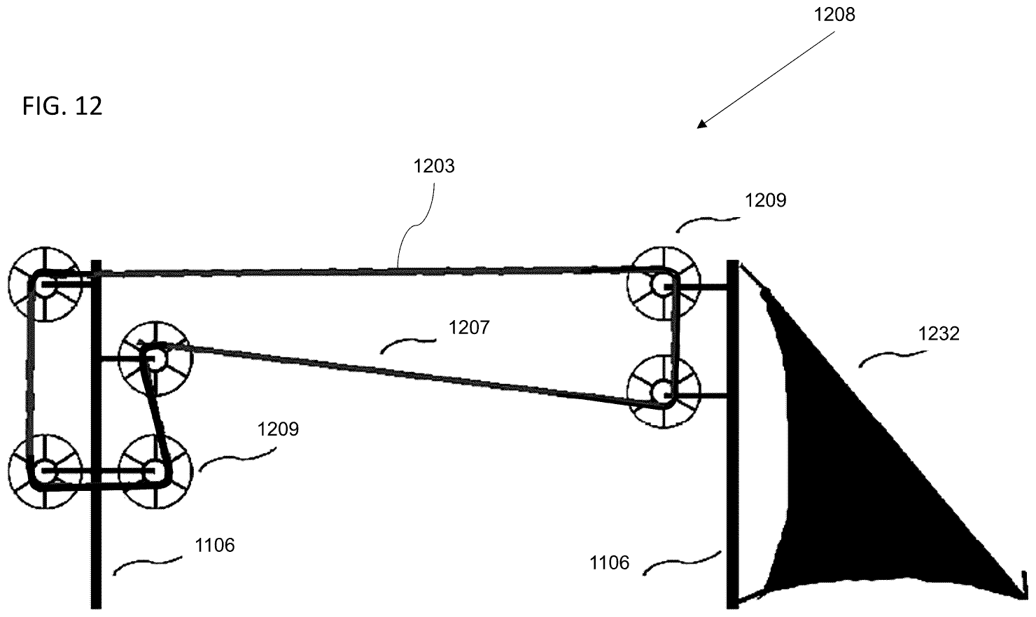

FIG. 14A is a view of a mobile cable-based power array in accordance with an embodiment of the current invention. FIG. 14B is a close-up view of the exemplary conveying system of the embodiment of FIG. 14A. In some embodiments, conveying apparatus including a actuator (e.g., a motor 1427) and/or a cable guide 1409 conveys rows of solar panels 1401 attached to a cable-based grid 1403 between a power generating position 1441 suspended above ground with a top face facing upwards toward the sun and between a cleaning position 1443 wherein the panels 1401 have been moved downward with a face vertical for cleaning. Optionally, a cleaning device 1405 (e.g., a tractor with an automatic brush and/or cleaning fluid sprayer) may drive along the row of panels 1401 and clean the panels in the cleaning positing 1443.

Optionally, once a row has been cleaned the cable guide 1409 rolls the array like a conveyer belt and/or moves another row to the cleaning position 1443. The row that was previously cleaned may be transported by the guide cable 1407 to a position 1449 below the power generating position 1441. Cleaning may be performed at night and/or during the day, all or many of the panels may be rolled back to the power generating position 1441 to produce electricity.

In some embodiments, an anchoring point 1406 includes a post to which a guide of the cable-based grid 1403 is attached. An anchoring device may include one of types (for example, as used in cable cars and/or ski lifts) [non-limiting examples are: a pole, a pillar, a building, a cliff, an antenna, a man-made structure, a floating anchor, a Marine anchor, the ground itself, and other anchor points known in previous knowledge].

In some embodiments, a solar panel cleaning device may include a cleaning device capable of removing undesired materials from at least one solar panel. For example, the cleaning device may include a brush to brush and/or a nozzle to spray cleaning fluid (e.g., water). Optionally, the cleaning device moves around a cleaning area. In some embodiments the cleaning device may include an adjustable length connection (e.g., to electricity and/or to a water source) for example, similar to the adjustable length connection described in connection to FIG. 13. Optionally, a cleaning device may include an independent vehicular platform (e.g., as illustrated by cleaning device 1405) alternatively or additionally, the cleaning device run on a track. Alternatively or additionally, the cleaning device may remain stationary. For example, a cleaning device 1111 may cover a line across a cleaning section and/or clean solar panels of a whole row together and or the rows of solar cells may be conveyed to the cleaning location. Optionally, a panel cooling device is combined with a cleaning device. Non limiting examples for a solar panel cleaning device include: a cleaning device using a stream of water and/or other cleaning liquids, cleaning devices using gasses like air or steam, a cleaning device using contact devices (e.g., linear moving brushes, stationary brushes across which the panels pass, rotating brushes and mops etc.), cleaning device using vacuum, cleaning device using ultrasound, other cleaning devices and methods. In some embodiments a solar panel cleaning device includes a device for collecting the excess water that is used, optionally, collected water could be recycled or discarded.

In some embodiments a panel cleaning device 1405 includes a mobilizing device (for example, the tractor carrying the rotating brushes of device 1405). For example, a mobilizing device may be coupled to a solar panel cleaning device in a way that facilitates the solar panel cleaning device covering a larger area than it would cover without the mobilizing device. And the mobilizing device for solar panel cleaning device 1405 could be manually operated and/or autonomously operated and/or remotely operated via a computerized robotic subsystem coupled to it.

Non limiting examples of a mobilizing device for solar panel cleaning device include:
mounting the solar panel cleaning device on a motorized or non-motorized vehicle.
mounting the solar panel cleaning device on a motorized or non-motorized ship or vessel.
coupling the solar panel cleaning device to a cable-based mobilizing device.

In some embodiments a solar panel cleaning device may include components similar to systems and methods used in external cleaning of building and/or in sport events filming, and/or in 3d printing devices.

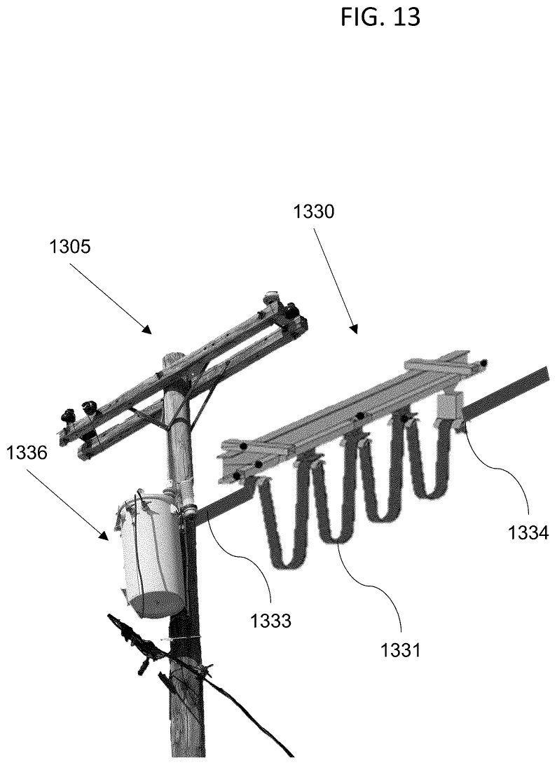

FIG. 15 is a view of a mobile cable-based power array in accordance with an embodiment of the current invention. In some embodiments an array of solar panels 1401 may be arranged on cable-based grids 1403. Optionally, the cable-based grids 1403 are in the form on continuous loop conveyer belt and/or each grid 1403 carries a plurality of panels 1401. Optionally, each grid 1403 is driven by a cable guide 1409. For example, rows of panels 1401 are moved between a sun exposed position 1462 (e.g., an upper position 1462 on top of the device where the panels 1401 are exposed to sun and/or generate power) and a maintenance position 1463 (e.g., near the ground and/or lower than the exposed position) and/or a waiting position 1449 (e.g., below the exposed position 1462). Alternatively or additionally, a cleaning position may be elevated and/or the cleaning device may move on maintenance shelf and/or track raised to the height of the panels. In some embodiments, an elevated maintenance area will enhance separation from the activity that is happening on the ground from activity of the solar power system such as maintenance of the solar power generating system.

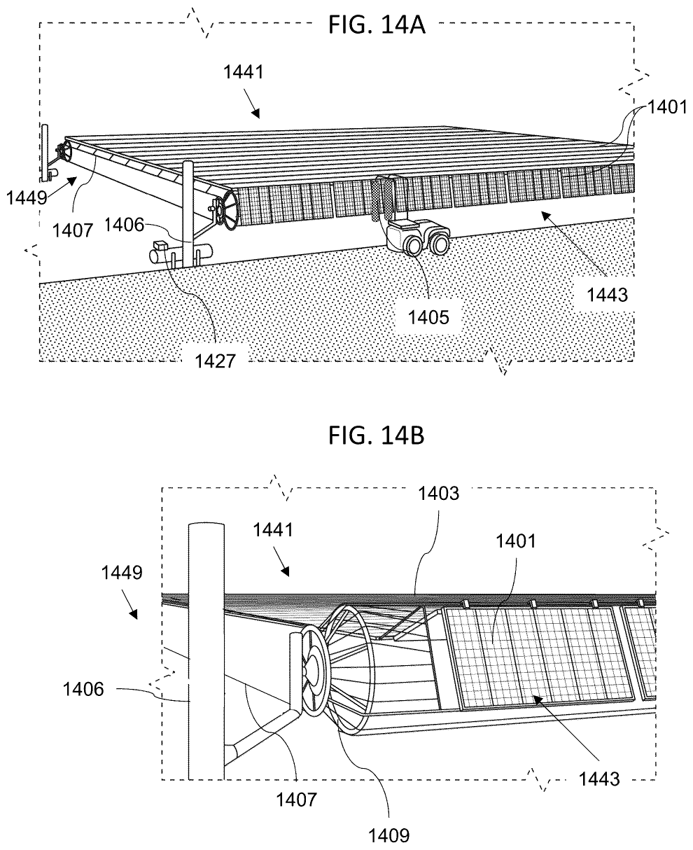

FIG. 16 is a view of a mobile cable-based power array passing over a roadway in accordance with an embodiment of the current invention. In some embodiments an array of solar panels 1601 may be arranged on a cable-based grid 1603. Optionally, the cable-based grid 1603 is in the form on continuous loop conveyer belt and/or carries a plurality of panels 1601. Optionally, the grid 1603 is driven by a conveyer apparatus, for example, including a cable guide 1609 on an anchor point 1606. For example, rows of panels 1601 are moved between a sun exposed position on top of the device (e.g., an upper position 1662) and a lower position (e.g., maintenance position 1663 and/or returning portion 1664). For example, a maintenance area may include an elevated platform 1668 elevated to approximately the height of the solar panel system, very slightly above ground level [for example, a cleaning apparatus 1605 moves along on top of the shelf]. For example, the platform 1668 may be elevated between 1 to 3 meters and/or between 3 to 10 meters and/or between 10 to 50 meters.

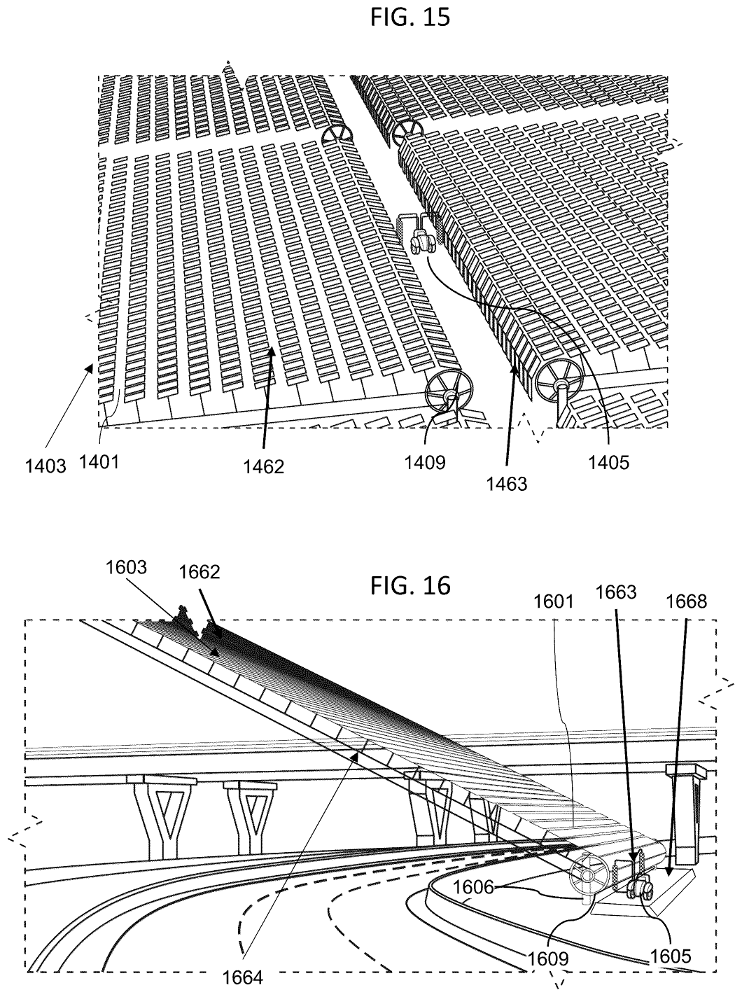

FIG. 17A is a view of a mobile cable-based power with panels tilted in accordance with an embodiment of the current invention. In some embodiment of the present invention solar panels 1701 may be tilted to follow the sun. For example, a tilting subsystem may be integrated in and/or coupled to a mobile cable-based solar panel array.

In some embodiments, sun following device is coupled to a solar panel 1701 or to an embodiment of a cable-based grid 1703 in a way that facilitates solar panels 1701 following the movement of the sun across the sky. Alternatively or additionally, the tilting system may be used to decrease wind resistance of the solar panels 1701 when necessary.

A non limiting example is illustrated in FIG. 17. For example, a row of panels 1701 are connected on a first edge (e.g., a top edge 1765) by an axle 1767 to a guide cable 1702 (see FIG. 17C). Optionally, stiff axle 1767 to hold and/or rotate the fixed edge (e.g., the top) of the panels 1701. A second (e.g., bottom/free) edge 1766 of the panels 1701 is optionally attached to a raising cable 1768. For example, when cable 1768 is tightened, it lifts the free end 1766 tilting the panel 1701 upwards. Optionally, a bar 1769 connects the between free ends of a row of panels 1701 and/or the raising cable 1768 e.g., for raising and/or lowering edges 1766 of multiple panels 1701 simultaneously and/or for inhibiting the free edge 1766 from uncontrolled movement and/or collisions between panels 1701. For example, a pulley wheel 1770 may interconnect between cable 1768 and axle 1767 and/or bar 1769. For example, cable 1768 runs over, is supported by and/or rotates wheels 1770. Optionally, bar 1769 may be attached to the bottom of the panels 1701 near the free edge 1766. The mechanism may be similar to the above-described apparatus designed to reduce or increase the wind obstruction of a solar panel. For example, a panel by 1701 to track the movement of the sun as it changes its position in the sky throughout the months of the year. For example, when the sun is low in the sky [at winter time] cable is released to allow a bigger angle in relation to the ground [closer to being vertical] and doing the opposite in summer time.

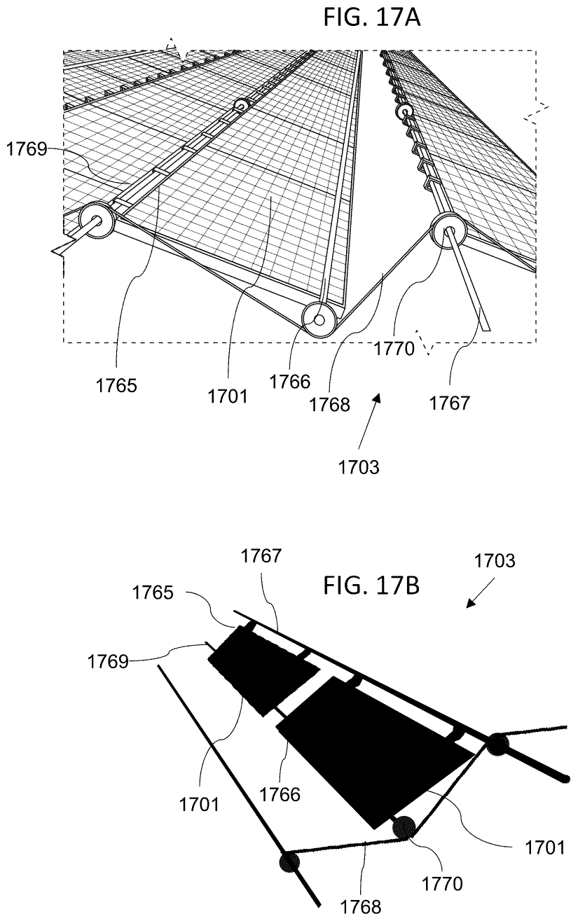

FIG. 18 is a block diagram of a mobile power array in accordance with an embodiment of the current invention. In some embodiments, a portion of a mobile solar array 1802 (for example, an array of solar panels connected to a cable-based grid) is conveyed by a conveyer apparatus 1817 and/or led by a cable guide 1809 between a maintenance area 1863 and a solar exposure area 1862. For example, the panels may be moved to the solar exposure area 1862 facing upwards during the day and moved for cleaning and/or other maintenance at night. The maintenance area 1863 may be closer to the ground than the solar exposure area 1862 and/or near an elevated platform (e.g., supporting the back of panels and/or on which workers stand and/or on which equipment is supported). The system may have various additions and/or attributes as illustrated in any of the embodiments herein disclosed.

In some embodiment of the present invention a solar collecting array 1802 is elevated above the ground. Optionally, a conveying apparatus 1817 and/or cable guide 1809 conveys solar panels from the array back and forth between a solar exposure area 1863 where the panels are exposed to sunlight and a maintenance area 1862 facilitating maintenance of the panels (e.g., near the ground and/or near an elevated maintenance area etc.). Optionally, the guide 1809, conveying apparatus 1817 and/or an anchor point is coupled to one or more devices in a way that creates a Dual Use of the same land area. In some embodiments, the device may use the electricity produced by the elevated above ground solar panel array or alternatively, the device may not use the power produced by the array.

In some embodiment of the present invention a solar collecting array 1802 and/or anchor points support and/or are connected to a device or a system that emits light and/or heat. For example, light and/or heat may be emitted downwards. For example, the system may create a dual-purpose apparatus combining a device harvesting solar power with a device lighting and/or heating an area underneath it. Non limiting examples of areas that may be heated and/or lit include a park, an urban area, a port, an agricultural facility or field, a fish farm, a parking lot, a work place, a road.

In some embodiment of the present invention a solar collecting array 1802 and/or anchor points support and/or are connected to an irrigation system and/or water supply system.

In some embodiment of the present invention a solar collecting array 1802 and/or anchor points support and/or are connected to a security system.

In some embodiment of the present invention a solar collecting array 1802 and/or anchor points support and/or are connected to a wind energy harvesting device with or without a wind funneling device.

In some embodiment of the present invention a solar collecting array 1802 and/or anchor points support and/or are connected to an advertising apparatus (e.g., a billboard, an electronic billboard, a billboard light etc.).

In some embodiment of the present invention a solar collecting array 1802 and/or anchor points support and/or are connected to a device to reduce evaporation from a body of water or from plants. Alternatively or additionally, the collecting array 1802 itself (e.g., shade from the array 1802) may reduce evaporation of the water.

In some embodiment of the present invention the cable-based grid 1203 may be configured to move in various directions, for example, upwards and/or downwards and/or laterally. Optionally bends in the movement may also be up, down and/or horizontal.

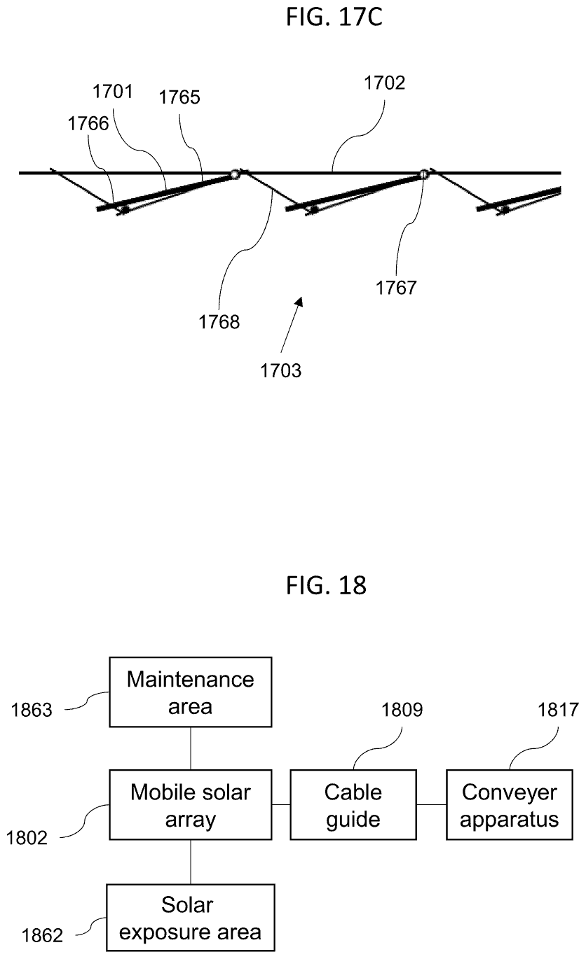

FIG. 19 is a schematic illustration of a mobile cable-based power array with an elevated maintenance area in accordance with an embodiment of the current invention.

In some of the embodiments of the current patent there is a support 1951b behind panels 1901 in the area where cleaning and/or maintenance operations are performed. Optionally, support 1951b may be rigid and/or support the rear of the panels. Optionally, the rear support 1951b facilitates the cleaning system to clean better due to the resistance of the support to the pressure that the cleaning system (e.g., brushes) exerts on the panels 1901. Non-limiting examples of materials for the support 1951b include: strip of hard material [for example, a strip of hard plastic material around which the panels move in the maintenance area], a metal frame on which a cable-based grid 1903 is tightly stretched capable of supporting the panels while they and/or a cable spaced grid 1903 are conveyed by a cable guide 1909 in the area designated for maintenance and/or a kind of rotating drum on which the panels rotate in the maintenance area. For example, the array of panels 1901 may travel as a unit with different parts of the array passing through for example the area 1943 designated for maintenance (e.g., near the ground and/or an elevated platform 1951a and/or an area of support 1951b) and/or an area 1941 exposed to the sun for producing energy and/or a waiting area 1949.

In some embodiments, there is maintenance platform 1951a that facilitates cleaning and maintenance. For example, workers and/or equipment may stand on the platform 1951a. Optionally the platform may be elevated at a height that may reduce disruption to what is going on above ground level. The platform may be similar to system above a road or a stream channel to which access below ground level is limited [e.g., similar to the maintenance shelf on tall billboards. Optionally, there may be a safety component for the aforementioned maintenance shelf [a safety cable to prevent falls, a safety rail, etc.]. Optionally, there may be a modular component (e.g., a variable length hose and/or cable) that carries electrical and/or water and/or air infrastructures along the maintenance platform 1951a (for example, as illustrated in FIG. 13). In some embodiments, a rail may be supplied on which a vehicle moves on which the cleaning and maintenance work is carried out. [See drawing]

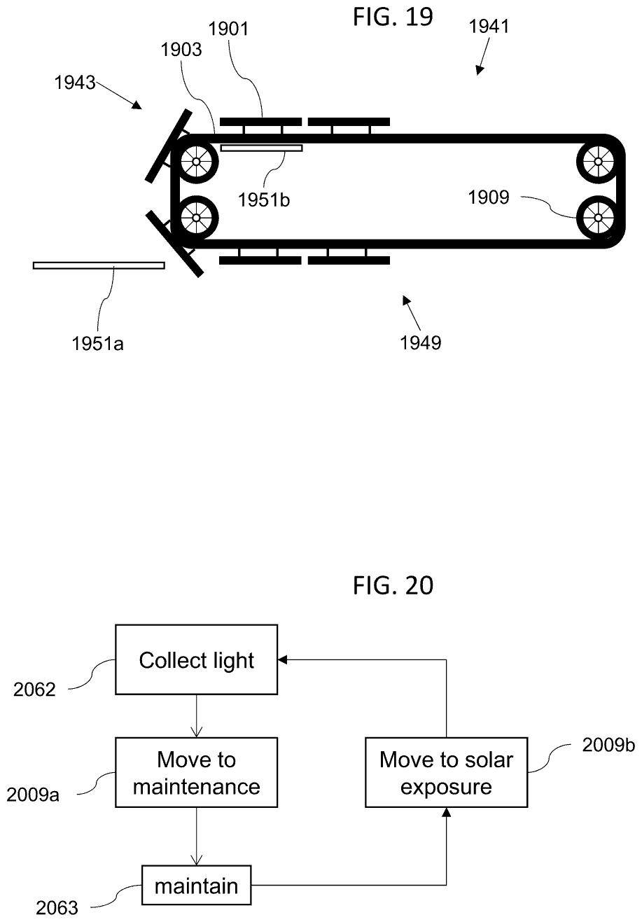

FIG. 20 is a flow chart illustration of use of a mobile solar power array in accordance with an embodiment of the current invention. In some embodiments, solar panels are moved 2009b to a collection area to collect 2062 solar energy and/or produce power, for example, during the day. Optionally, the panels are moved 2009a to a maintenance area (for example, at night) where cleaning and/or other maintenance may be performed 2063. In some embodiments, various functions may be performed by any of the embodiments described herein.

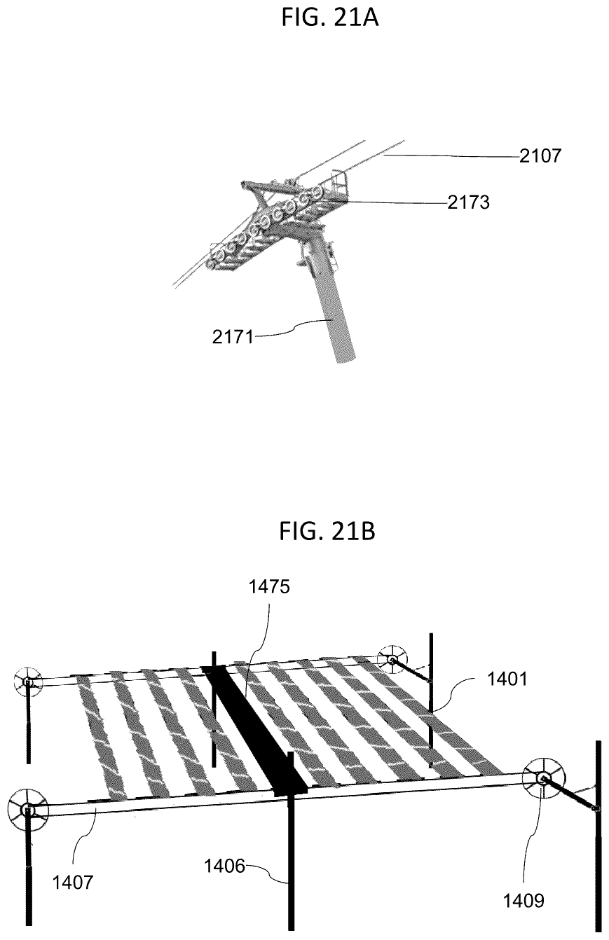

FIG. 21A is a schematic illustration of a mid-cable support for a mobile cable-based power array in accordance with an embodiment of the current invention. In some embodiments, a tower 2171 and/or pulley support wheel 2173 may be used to support a guide cable 2107 and/or a cable of a cable-based grid etc.

FIG. 21B is a schematic illustration of a mobile cable-based power array including a mid-grid support 1475 in accordance with an embodiment of the current invention. In some embodiments, a mid-cable support 1475 may pass under section of the cable-based grid. For example, support 1475 passes across the width of the cable-based grid and/or supports a row of solar panels 1401 and/or supports a portion of a guiding cable 1407. Alternatively or additional, a mid-cable support may run lengthwise along the cable supported grid and/or support a section of multiple rows of cells.

Optionally The supporting system can include a facility that allows controlling the degree of support provided to the solar system, for example giving full support while the system is stationary and partial or zero support when the system is moving, this feature can prevent interference from the support side to the movement of the system towards the maintenance area

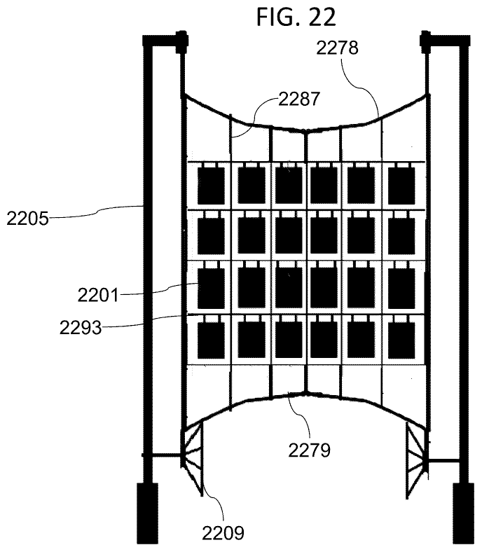

FIG. 22 is a schematic illustration of a suspension cable support for a vertical mobile cable-based power array in accordance with an embodiment of the current invention. In some embodiments, in vertical and/or horizontal and/or mainly vertical systems and/or partly vertical systems it is possible to straighten the rows of panels by using cables of different lengths to support the row of panels, as is done for example, in suspension bridges such as the Golden Bridge in San Francisco

In some cases, cables bowing downward can have a negative effect on the performance of the solar system. Optionally, in order to eliminate and/or reduce the arc that is created, the system may include differential cable support, that is, support with cables of different lengths in a way that aligns the rows of solar panels. Support cables of different lengths optionally facilitate control and the creation of a straight line of panels similarly to how vertical support cables support a straight and/or upwardly arched bridge from downwardly arched suspension cable

For example, a cable 2278 suspended between two anchors 2205 and/or two cable guides 2209 may bow (for example cable 2278 bows downward and/or cable 2279 bows downward). A cable-based grid 2293 and/or solar panels 2201 may be supported by the cable 2278, 2279. Optionally, variable length vertical suspender cables 2287 may be used to keep the cable-based grid 2293 and/or panels 2201 flat and/or facing in the same direction. Optionally support cables may be connected to a guide cable. For example, the vertical cable-based grid 2293 may be moved to position some of the panels (e.g., a row of panels) in a maintenance area.

Optionally, the panels and/or a cable-based grid may be supported from a cable support using vertical suspenders. Optionally, the vertical suspenders may be of different lengths (e.g., short in the middle and/or long near supports).

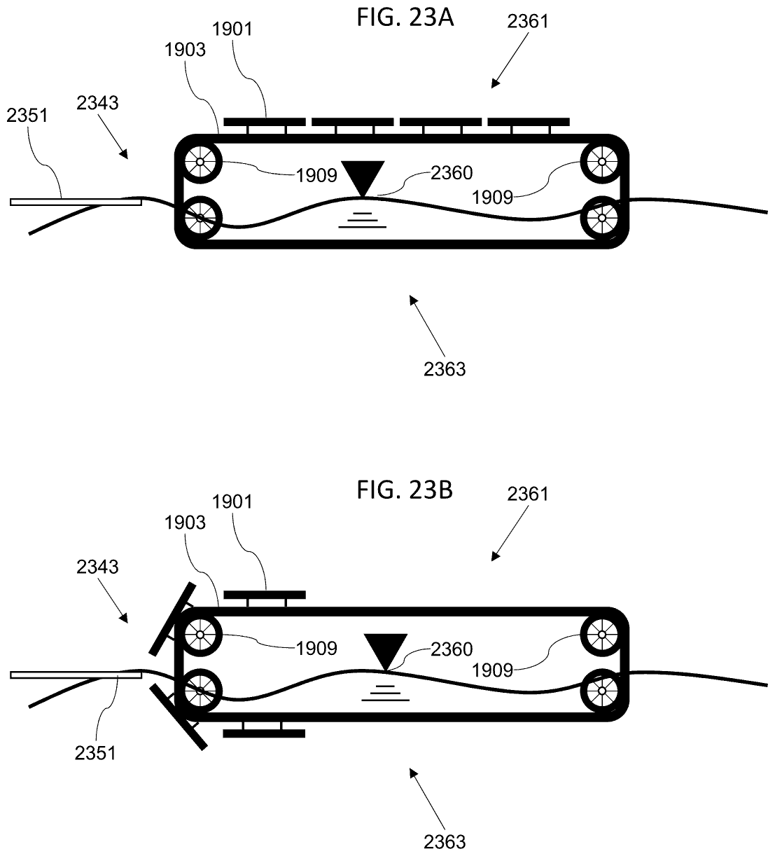

FIG. 23A is a schematic illustration of an overwater mobile cable-based power array in a power producing position 2361 accordance with an embodiment of the current invention. In the power producing position 2361, the solar panels 1901 may be positioned on the top of the system and/or facing the sun.

FIG. 23B is a schematic illustration of an overwater mobile cable-based power array in a maintenance position accordance with an embodiment of the current invention. In the maintenance position, some of the solar panels 1901 may be located in a maintenance area 2343.

Optionally, the system includes a floating and/or suspended platform 2351 from which workers and/or equipment can access the maintenance area 2343.

In some embodiments, a system may float on water and/or be suspended over water. Optionally, the system that is not elevated and suspended in the air, but is placed to float on the surface 2360 of the water and/or panels may be connected to a conveyer belt type cable-based grid 1903. The top solar conducting side of the grid may float above the water and/or be exposed to the sun. The bottom 2363 of the grids, i.e., into the water below them upside down as in the elevated systems. The grid 1903 may be driven and/or guided by a cable guide 1909.

In some embodiments, a separation layer may separate between the top and the bottom 2363 portion for example, to prevent collision at the stage when the panels go from an upper position with their faces towards the sky to a lower position with their faces towards the ground [for example, some type of fabric and/or some type of mesh and/or some type of plastic sheet connected to the system between the upper layer of a number of panels and the layer in which they will find that they will turn around and reach upside down in the water. In some embodiments, a portion of the maintenance area of the system may be underwater.

It is possible to add at least one component that reduces friction, for example, wheels or rollers that move freely in the direction of movement of the grid.

In the system area on water with and without separation to prevent damage including beads to reduce friction, or friction using wheels or using rails including a rear support surface for the maintenance area which is at sea level and not elevated.

In some embodiments, a suspended and/or mobile solar collecting system may be combined with other energy harvesting system, for example, a wind energy harvesting system and/or a sea wave harvesting, tidal harvesting and harvesting of water currents system.

It is expected that during the life of a patent maturing from this application many relevant technologies will be developed and the scope of the terms is intended to include all such new technologies a priori.

As used herein the term “about” refers to □ 10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example, the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A solar power harvesting system comprising:
a flexible solar array including a cable-based lattice and a plurality of solar panels attached thereto and at least partially elevated above a ground surface;
a conveyer configured for transporting said flexible solar array such that a portion of the plurality of solar panels moves back and forth between a predetermined maintenance area and a predetermined power generating position
wherein the conveyer includes at least one cable guide guiding a guide cable to perform said transporting and said cable guide includes a channel wherein the guide cable passes through an internal space of the channel and a portion of the cable-based lattice passes through a side slit of the channel.

2. (canceled)

3. A solar power harvesting system comprising:
a flexible solar array including a cable-based lattice and a plurality of solar panels attached thereto and at least partially elevated above a ground surface;
a conveyer configured for transporting said flexible solar array such that a portion of the plurality of solar panels moves back and forth between a predetermined maintenance area and a predetermined power generating position
wherein the conveyer includes at least one cable guide guiding a guide cable to perform said transporting and
wherein the conveyer includes a small diameter drive wheel driving said guide cable and wherein said cable guide includes a rotating large diameter component directing movement the flexible solar array around a change in direction.

4. (canceled)

5. The solar power harvesting system of claim 1, wherein said cable guide includes series of rings wherein the guide cable passes through an internal space of the rings and a portion of the cable-based lattice passes through an opening in each of the rings.

6. The solar power harvesting system of claim 3, wherein said large diameter component includes protruding teeth.

7. The solar power harvesting system of claim 1, wherein the conveyer includes at least two guide cables attached to opposing sides of said flexible solar array and a respective cable guide for guiding each said guide cable.

8. The solar power harvesting system of claim 7, wherein at least one of said cable guides in the conveyer includes a small diameter drive wheel driving said guide cable and wherein said cable guide includes a rotating large diameter component directing movement the flexible solar array around a change in direction.

9. (canceled)

10. The solar power harvesting system of claim 8, wherein flexible solar array has a form of a continuous belt.

11. The solar power harvesting system of claim 1, wherein a portion of said plurality of panels is configured for tilting comprising an angle adjusted apparatus to control an angle of said tilting.

12-17. (canceled)

18. The solar power harvesting system of claim 1, wherein said maintenance area is elevated above said ground surface.

19. (canceled)

20. The solar power harvesting system of claim 1, further including another renewable energy harvesting device.

21. The solar power harvesting system of claim 1, further including a wind blocking device.

22. The solar power harvesting system of claim 1, further including a tensioning device configured to increase and decries tension in at least one cable in said flexible cable-based solar array.

23. The solar power harvesting system of claim 1,
at least partially floating on a body of water.

24. A method of solar power harvesting comprising:
Suspending a flexible solar array on a guide cable above an object;
Conveying said guide cable via a pulley on a small diameter drive wheel thereby moving said flexible solar array while directing movement of said flexible solar array around a change of direction with a rotating large diameter component thereby transporting a portion of the array between a maintenance area and a power generating position.

25. The A solar power harvesting system of claim 1, further comprising a friction reducing device between said guide cable and said cable guide.

26. The solar power harvesting system of claim 3, wherein the conveyer includes at least two guide cables attached to opposing sides of said flexible solar array and a respective cable guide for guiding each said guide cable.

27. The solar power harvesting system of claim 3, wherein a portion of said plurality of panels is configured for tilting comprising an angle adjusted apparatus to control an angle of said tilting.

28. The solar power harvesting system of claim 3, further including another renewable energy harvesting device.

29. The solar power harvesting system of claim 3, further including a wind blocking device.

30. The solar power harvesting system of claim 3, further including a tensioning device configured to increase and decries tension in at least one cable in said flexible cable-based solar array.
